(19) United States
(12) Patent Application Publication
(10) Pub. No.: US 2022/0032455 A1
(43) Pub. Date: Feb. 3, 2022

(54) ESTIMATION APPARATUS, ESTIMATION METHOD, AND ESTIMATION PROGRAM

(71) Applicant: SONY GROUP CORPORATION, TOKYO (JP)

(72) Inventors: SHINICHIRO GOMI, TOKYO (JP); MASANORI IWASAKI, TOKYO (JP); KEN HAYAKAWA, TOKYO (JP); NAOKI FUJIWARA, TOKYO (JP); TSUKASA YOSHIMURA, TOKYO (JP); AKINORI SHINGYOUCHI, TOKYO (JP); JUNICHI TANAKA, TOKYO (JP); AKIRA TANGE, TOKYO (JP)

(21) Appl. No.: 17/297,396

(22) PCT Filed: Nov. 8, 2019
(86) PCT No.: PCT/JP2019/043790

§ 371 Date: May 26, 2021

(30) Foreign Application Priority Data
Dec. 5, 2018 (JP) 2018-228574

(51) Int. Cl. B25J 9/16; G01S 13/08; G01B 11/30; B25J 13/08

(52) U.S. Cl. CPC B25J 9/1612; B25J 13/08; G01B 11/30; G01S 13/08

(57) ABSTRACT

An estimation apparatus includes: an acquisition section that acquires a measurement result of a measurement unit that measures an object to be an estimation target of a contact sense in a contactless manner; a determination section that makes a determination as to an aspect of the object or a measurement condition of the object on a basis of the measurement result of the measurement unit; a selection section that selects, on a basis of a result of the determination, an estimation scheme to be used for estimation of the contact sense of the object from among a plurality of estimation schemes; and an estimation section that estimates the contact sense of the object using the selected estimation scheme.

### TECHNICAL FIELD

The present disclosure relates to an estimation apparatus, an estimation method, and an estimation program.

### BACKGROUND ART

It has been required to grasp features of an object in a contactless manner. As an example of such a technique, there has been known a technique of contactless estimation of hardness of an object, a frictional coefficient of a surface of the object, or the like.

### CITATION LIST

### Patent Literature

PTL 1: Japanese Unexamined Patent Application Publication No. 2012-37420

PTL 2: Japanese Unexamined Patent Application Publication No. 2005-144573

### SUMMARY OF THE INVENTION

### Problem to be Solved by the Invention

Features of an object desired to be grasped in a contactless manner include a sense of being in contact with the object (e.g., tactile sense or force sense). Highly accurate contact sense information is extremely useful information in various aspects. However, the environment surrounding an object to be an estimation target of the contact sense varies, and the object itself to be the estimation target of the tactile sense also varies. In such a situation, it is not easy to accurately estimate the contact sense of the object in a contactless manner.

The present disclosure therefore proposes an estimation apparatus, an estimation method, and an estimation program that make it possible to accurately estimate a contact sense of an object in a contactless manner.

### Means for Solving the Problem

In order to solve the above-described issues, an estimation apparatus according to an embodiment of the present disclosure includes: an acquisition section that acquires a measurement result of a measurement unit that measures an object to be an estimation target of a contact sense in a contactless manner; a determination section that makes a determination as to an aspect of the object or a measurement condition of the object on a basis of the measurement result of the measurement unit; a selection section that selects, on a basis of a result of the determination, an estimation scheme to be used for estimation of the contact sense of the object from among a plurality of estimation schemes; and an estimation section that estimates the contact sense of the object using the selected estimation scheme.

### BRIEF DESCRIPTION OF THE DRAWINGS

FIG. 1 illustrates a configuration example of an estimation apparatus according to Embodiment 1.

FIG. 2 illustrates a state in which a measurement unit measures an object to be an estimation target of a contact sense in a contactless manner.

FIG. 3 illustrates relationships among blocks included in the estimation apparatus.

FIG. 4 illustrates a specific configuration example of a broken line part indicated in FIG. 3.

FIG. 5 illustrates the relationship diagram illustrated in FIG. 3 in more detail.

FIG. 6 illustrates a state in which an object T is measured by the measurement unit.

FIG. 7A is an explanatory diagram of a calculation example of a surface roughness factor.

FIG. 7B is an explanatory diagram of another calculation example of the surface roughness factor.

FIG. 8 is an explanatory diagram of contrast calculation processing.

FIG. 9A illustrates an example of a calibration curve.

FIG. 9B illustrates an example of a calibration curve.

FIG. 9C illustrates an example of a calibration curve.

FIG. 10 illustrates a state in which a calibration curve is used to calculate tactile information.

FIG. 11 is a flowchart illustrating contact sense estimation processing according to Embodiment 1.

FIG. 12 illustrates a configuration example of an estimation system 1 according to Embodiment 2.

FIG. 13 illustrates relationships among blocks included in the estimation apparatus.

FIG. 14 illustrates an example of commodity information.

FIG. 15 is a flowchart illustrating commodity information transmission processing according to Embodiment 2.

FIG. 16 illustrates an example of commodity information processed into a format suitable for browsing.

FIG. 17 illustrates an example of transmission of information on similar commodities together with information on a designated commodity.

FIG. 18 illustrates a configuration example of an estimation apparatus 10 according to Embodiment 1.

FIG. 19 illustrates in detail relationships among the blocks included in the estimation apparatus.

FIG. 20 is a flowchart illustrating grip control processing according to Embodiment 3.

FIG. 21 illustrates a state in which the estimation apparatus decides a grip position.

FIG. 22 illustrates a configuration example of an estimation apparatus according to Embodiment 4.

FIG. 23 illustrates in detail relationships among the blocks included in the estimation apparatus.

FIG. 24 illustrates a measurement example of shear (wave velocity) using a surface unevenness measure.

FIG. 25A illustrates an example of a calibration curve.

FIG. 25B illustrates an example of a calibration curve.

FIG. 25C illustrates an example of a calibration curve.

FIG. 26A illustrates an example of a calibration curve.

FIG. 26B illustrates an example of a calibration curve.

FIG. 26C illustrates an example of a calibration curve.

FIG. 27 is a flowchart illustrating contact sense estimation processing according to Embodiment 5.

### MODES FOR CARRYING OUT THE INVENTION

Hereinafter, description is given in detail of embodiments of the present disclosure with reference to the drawings. It is to be noted that, in each of the following embodiments, repeated description is omitted by assigning the same reference numerals to the same parts.

Description is given of the present disclosure in accordance with the order of items indicated below.

### 1. Introduction

### 2. Embodiment 1

2-1. Configuration of Estimation Apparatus
2-2. Operation of Estimation Apparatus

### 3. Embodiment 2 (Electronic Commerce Transaction)

3-1. Configuration of Estimation System
3-2. Operation of Estimation System

### 4. Embodiment 3 (Robot Hand)

4-1. Configuration of Estimation Apparatus
4-2. Operation of Estimation Apparatus

### 5. Embodiment 4 (Brace)

5-1. Configuration of Estimation Apparatus
5-2. Operation of Estimation Apparatus

### 6. Modification Examples

### 7. Closing

### 1. Introduction

An estimation apparatus 10 of the present embodiment is an apparatus for contactless estimation of a contact sense of an object. As used herein, the contact sense refers to a sense of a person who comes in contact with the object. For example, the contact sense refers to a tactile sense or force sense of the object. As used herein, the tactile sense of the object is, for example, a skin sensation felt when a person strokes an object surface. The “tactile sense” may be rephrased as another expression such as “texture”. In addition, the force sense of the object is, for example, a sense of reaction force felt by a person when coming into contact with the object. The tactile sense and the force sense may be collectively referred to as tactile force sense in some cases. It is to be noted that the contact sense is not limited to the tactile sense or the force sense. One of the tactile sense and the force sense may be set as the contact sense. The estimation apparatus 10 of the present embodiment estimates the contact sense of an object in a contactless manner, and outputs estimation results as contact sense information. The contact sense information may be information based on a human sensory evaluation such as a “degree of coarseness” or a “degree of springiness”, or may be information indicating physical properties of an object such as hardness, a frictional coefficient, an elastic modulus, and the like of an object.

Various methods are conceivable for a method of estimating the contact sense of an object. For example, as one of the methods of estimating the contact sense of an object, a method using an ultrasonic wave is conceivable. For example, the estimation apparatus irradiates an ultrasonic wave to an object to be an estimation target of the contact sense to measure deformation caused by the ultrasonic wave. Then, the estimation apparatus estimates hardness of a surface of the object on the basis of data of the measured deformation. However, it is difficult for this method to irradiate an ultrasonic wave with intensity necessary for estimation in a case where the object and an ultrasound irradiator is distant from each other. Therefore, there is a possibility that the estimation apparatus may not be able to accurately estimate the hardness of the surface of the object in this method. In addition, this method is not usable in a case where the deformation of a measurement target is not desirable.

In addition, as another example of the method of estimating the contact sense of an object, a method of using an estimation equation representing a relationship between an image feature amount and a static frictional coefficient is conceivable. For example, the estimation apparatus captures an image of an object, and extracts a feature amount of the captured image. Then, the estimation apparatus uses an estimation equation that represents a relationship between an extracted image feature amount and a static frictional coefficient to estimate a static frictional coefficient of the object surface from the image feature amount. However, in a case of this method, the estimation apparatus estimates the static frictional coefficient on the basis of a feature derived from the image captured at a certain setting (distance). Therefore, in a case where a nearby small feature and a distant large feature are captured to be the same size on the image, the estimation apparatus may possibly misestimate the frictional coefficient. In addition, in a case where the setting of the image capturing is changed, it is necessary to change the estimation equation.

In addition, as another example of the method of estimating the contact sense of the object, a method of using a neural network is also conceivable. For example, the estimation apparatus captures an image of an object, and extracts a feature amount of the captured image. Then, the estimation apparatus uses a neutral network having learned a relationship between an extracted image feature amount and a static frictional coefficient to estimate a static frictional coefficient of the object surface from the image feature amount. However, also in a case of this method, the estimation apparatus estimates the static frictional coefficient on the basis of a feature obtained from the image captured at a certain setting (distance). Therefore, in a case where a nearby small feature and a distant large feature are captured to be the same size on the image, the estimation apparatus may possibly misestimate the frictional coefficient, similarly to the method of using the estimation equation. In addition, in a case where the setting of the image capturing is changed, it is necessary for the estimation apparatus to relearn the neural network.

Therefore, in the present embodiment, the estimation apparatus 10 measures an object to be an estimation target of the contact sense in a contactless manner, and makes a determination as to an aspect of the object or a measurement condition of the object on the basis of measurement results. Then, on the basis of the result of this determination, the estimation apparatus 10 selects an estimation scheme to be used for estimation of the contact sense of the object from among a plurality of estimation schemes. Then, the estimation apparatus 10 uses the selected estimation scheme to estimate the contact sense of the object. This enables the estimation apparatus 10 to use an optimum estimation scheme corresponding to the aspect of the object or the measurement condition of the object, thus making it possible to accurately estimate the contact sense of the object.

### 2. Embodiment 1

Hereinafter, description is given in detail of the estimation apparatus 10 according to Embodiment 1. In Embodiment 1, suppose that the contact sense to be estimated by the estimation apparatus 10 is a tactile sense. An object to be an estimation target of the tactile sense is a tea bowl, for example. It is to be noted that the contact sense to be estimated by the estimation apparatus 10 is not limited to the tactile sense. The term “tactile sense” that appears in the following description may be replaced with another term indicating the contact sense such as the “force sense” or the “tactile force sense” as appropriate.

### <2-1. Configuration of Estimation Apparatus>

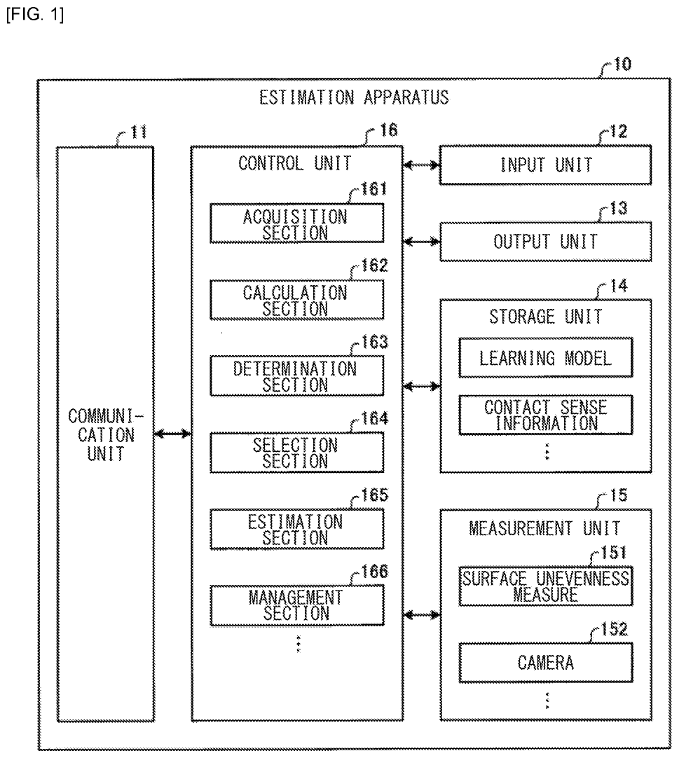

First, description is given of a configuration of the estimation apparatus 10. FIG. 1 illustrates a configuration example of the estimation apparatus 10 according to Embodiment 1. The estimation apparatus 10 includes a communication unit 11, an input unit 12, an output unit 13, a storage unit 14, a measurement unit 15, and a control unit 16. It is to be noted that the configuration illustrated in FIG. 1 is a functional configuration, and a hardware configuration may be different therefrom. In addition, functions of the estimation apparatus 10 may be implemented discretely in a plurality of physically separate apparatuses.

The communication unit 11 is a communication interface for communicating with other apparatuses. The communication unit 11 may be a network interface, or may be an apparatus-coupling interface. For example, the communication unit 11 may be a LAN (Local Area Network) interface such as an NIC (Network Interface Card), or may be a USB interface configured by a USB (Universal Serial Bus) host controller, a USB port, or the like. In addition, the communication unit 11 may be a wired interface, or may be a wireless interface. The communication unit 11 functions as a communication means of the estimation apparatus 10. The communication unit 11 communicates with other apparatuses under the control of the control unit 16.

The input unit 12 is an input interface for a user to input information. For example, the input unit 12 is an operation device for a user to perform an input operation, such as a keyboard, a mouse, an operation key, or a touch panel. The input unit 12 functions as an input means of the estimation apparatus 10.

The output unit 13 is an input interface for a user to input information. For example, the output unit 13 is a display device such as a liquid crystal display (Liquid Crystal Display) or an organic EL display (Organic Electroluminescence Display). Alternatively, the output unit 13 is an acoustic device such as a speaker or a buzzer. The output unit 13 may be a lighting device such as an LED (Light Emitting Diode) lamp. The output unit 13 functions as an output means of the estimation apparatus 10.

The storage unit 14 is a data-readable/writable storage device such as a DRAM (Dynamic Random Access Memory), SRAM (Static Random Access Memory), a flash memory, or a hard disk. The storage unit 14 functions as a storage means of the estimation apparatus 10. The storage unit 14 stores, for example, measured data of an object by the measurement unit 15 as well as contact sense information on an object estimated by the control unit 16. In a case where information on an image of an object captured by a camera is inputted, information on a learning model learned to output information concerning contact information on the object may be stored.

The measurement unit 15 is a measuring device that measures an object to be an estimation target of the contact sense in a contactless manner. For example, the measurement unit 15 is an RGB image sensor, a polarized image sensor, a distance-measuring sensor (ToF (Time of Flight) sensor, etc.), or an ultrasonic sensor. The measurement unit 15 may have a function of irradiating an object with light, a sonic wave, an ultrasonic wave, and the like necessary for measuring. The measurement unit 15 may be configured by a plurality of sensors. In addition, the measurement unit 15 may be a device integral with the estimation apparatus 10, or may be a separate device.

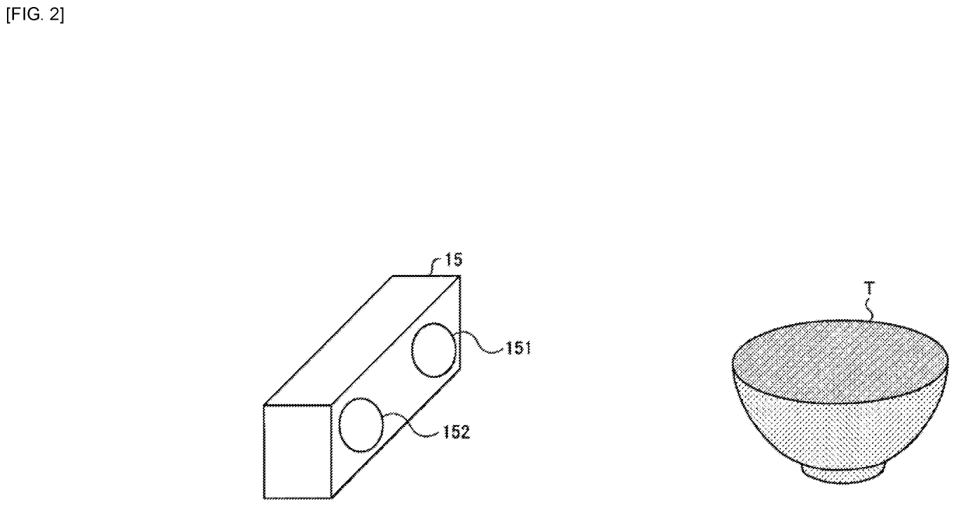

FIG. 2 illustrates a state in which the measurement unit 15 measures an object T to be an estimation target of the contact sense in a contactless manner. In the example of FIG. 2, the object T is a tea bowl. As illustrated in FIG. 2, the measurement unit 15 includes a surface unevenness measure 151 and a camera 152. It is to be noted that a plurality of measures (e.g., surface unevenness measure 151 and camera 152) included in the measurement unit 15 may be each regarded as a single measurement unit.

The surface unevenness measure 151 (a first measure) is a three-dimensional shape measuring camera, for example. The surface unevenness measure 151 may be a device that measures minute unevenness of an object surface using a sensor that is able to measure a target in a contactless manner (hereinafter, referred to as contactless sensor). At this time, the contactless sensor may be a light-receiving element that receives reflected light of the light (e.g., laser light) irradiated to the object. In addition, the contactless sensor may be an image sensor mounted on an RGB camera, or the like. A camera itself of the RGB camera may also be viewed as the contactless sensor. It is to be noted that the “surface unevenness” may be rephrased as “surface roughness”. For example, the “surface unevenness measure” may be rephrased by a “surface roughness measure” or the like.

The camera 152 is a camera including an image sensor that captures an image of an object. The camera 152 may be a monocular camera, or may be a stereo camera. The camera 152 may be a visible light camera (e.g., an RGB camera) that captures visible light, or may be an infrared camera that acquires a thermographic image.

Returning to FIG. 1, the control unit 16 is a controller (Controller) that controls each unit of the estimation apparatus 10. The control unit 16 is implemented by, for example, a processor such as a CPU (Central Processing Unit) or an MPU (Micro Processing Unit). For example, the control unit 16 is implemented by the processor executing various programs stored in the storage device inside the estimation apparatus 10 using a RAM (Random Access Memory), or the like as a work region. It is to be noted that the control unit 16 may be implemented by an integrated circuit such as an ASIC (Application Specific Integrated Circuit) or an FPGA (Field Programmable Gate Array). All of the CPU, the MPU, the ASIC, and the FPGA may be regarded as the controller.

As illustrated in FIG. 1, the control unit 16 includes an acquisition section 161, a calculation section 162, a determination section 163, a selection section 164, an estimation section 165, and a management section 166. Respective blocks (acquisition section 161 to management section 166) configuring the control unit 16 are functional blocks indicating functions of the control unit 16. These functional blocks may be software blocks, or may be hardware blocks. For example, each of the above-described functional blocks may be one software module implemented by software (including a microprogram), or may be one circuit block on a semiconductor chip (die). The functional blocks may each be one processor or one integrated circuit, as a matter of course. The method for configuring the functional blocks is arbitrary. It is to be noted that the control unit 16 may be configured by functional units different from the functional blocks described above.

### [Overview of Functions of Respective Blocks]

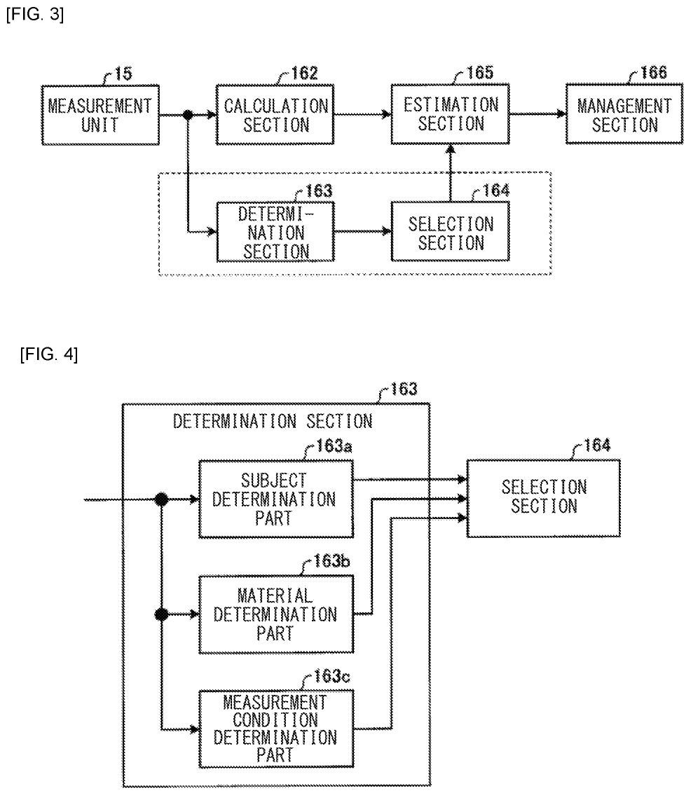

FIG. 3 illustrates relationships among blocks included in the estimation apparatus 10. Hereinafter, description is given of an overview of functions of the respective blocks.

It is to be noted that, in the following description, suppose that the estimation apparatus 10 estimates a tactile sensation of the object T. The object T is a tea bowl, for example. The object T is not limited to the tea bowl, as a matter of course. The object T may be a container other than the tea bowl, such as a glass, or may be an object other than the container, such as a stuffed toy. In addition, the object T is not limited to a specific object. A material (material quality) of the object T is a pottery, for example. The material is not limited to a specific material quality. The material of the object T is not limited to the pottery. For example, the material of the object T may be wood, may be plastic, or may be rubber. In addition, the material of the object T may not necessarily be a solid. In addition, the contact sense to be estimated by the estimation apparatus 10 is not limited to the tactile sensation. The tactile sensation that appears in the following description may be replaced with the “contact sense”, the “tactile force sense”, the “force sense”, or the like, as appropriate.

The measured data measured by the measurement unit 15 is inputted to the calculation section 162. The measured data to be inputted to the calculation section 162 is data of surface unevenness of the object T measured by the surface unevenness measure 151 as well as an image of the object T captured by the camera 152. The measured data is converted to a predetermined parameter (e.g., surface roughness factor) by the calculation section 162, and is used for estimation of a tactile sense of the object T.

The measured data measured by the measurement unit 15 is also inputted to the determination section 163. The determination section 163 makes a determination as to an aspect of the object T or a measurement condition of the object T on the basis of measurement results of the measurement unit 15. The selection section 164 selects an estimation scheme to be used by the estimation section 165 from among a plurality of estimation schemes on the basis of a result of the determination section 163. The estimation section 165 uses the estimation scheme selected by the selection section 164 from among the plurality of estimation schemes to estimate the tactile sense of the object T. The management section 166 stores estimation results of the estimation section 165 in the storage unit 14. The estimation scheme to be used by the estimation section 165 is described later in detail.

FIG. 4 illustrates a specific configuration example of a broken line part indicated in FIG. 3. The determination section 163 includes a subject determination part 163a, a material determination part 163b, and a measurement condition determination part 163c. The subject determination part 163a and the material determination part 163b determine the aspect of the object T. For example, the subject determination part 163a determines what the object T is on the basis of an image captured by the camera 152. The material determination part 163b determines a material (material quality) of the object T on the basis of the image captured by the camera 152. The measurement condition determination part 163c determines a measurement condition of the object T. For example, the measurement condition determination part 163c may determine whether or not a distance to the object T is within the range of a standard. The selection section 164 selects an estimation scheme to be used for estimation of the tactile sense of the object T from among the plurality of estimation schemes on the basis of determination results of the determination section 163.

### [Details of Functions of Respective Blocks]

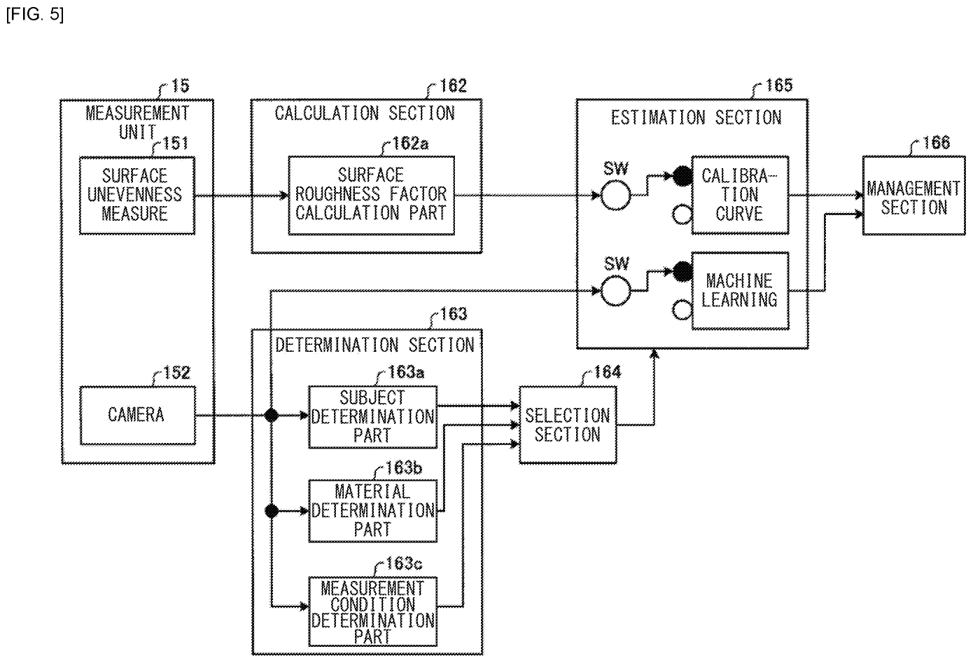

FIG. 5 illustrates the relationship diagram illustrated in FIG. 3 in more detail. Hereinafter, description is given in detail of functions of the respective blocks.

### (Measurement Unit)

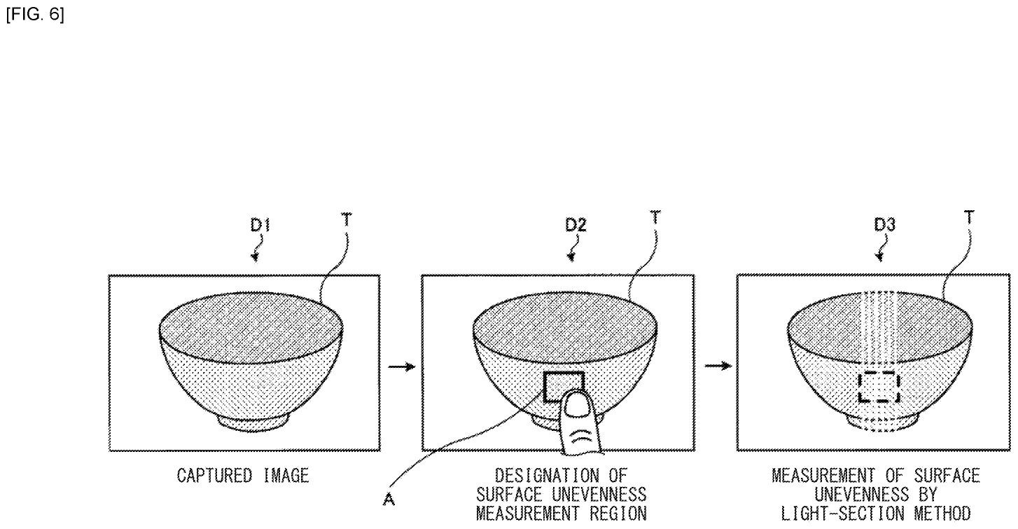

The measurement unit 15 includes the surface unevenness measure 151 and the camera 152, and performs various measurements of the object T. FIG. 6 illustrates a state in which the object T is measured by the measurement unit 15. The measurement unit 15 performs imaging of the entire object T with the camera 152, and measures minute unevenness on a surface of the object T with the surface unevenness measure 151. A condition D1 in FIG. 6 illustrates a state in which an image of the object T is captured by the camera 152. It is to be noted that the surface unevenness measure 151 may measure surface unevenness at the center of a field of view in the image. The range to be measured by the surface unevenness measure 151 may be a range designated by a user using the input unit 12. For example, a condition D2 in FIG. 6 illustrates a state in which the user designates a measurement range of the surface unevenness using a measure GUI. In a case of the example of FIG. 6, a measurement range A illustrated in the condition D2 is a measurement range designated by the user.

The surface unevenness measure 151 may use a light-section method to measure surface unevenness of the object T. A condition D3 in FIG. 6 illustrates a state in which the surface unevenness measure 151 uses the light-section method to measure the surface unevenness of the object T. White vertical lines in the diagram indicate line light generated on the object T. The line light may be generated by an unillustrated projector (e.g., laser irradiator) included in the measurement unit 15 or the surface unevenness measure 151. The surface unevenness measure 151 includes a sensor (e.g., light-receiving element or image sensor) that is able to capture a change in brightness, and grasps a change in shading with a sensor to thereby detect the surface unevenness of the object T. The sensor may be a camera. Examples of the light-section method include a method provided in journal of Institute of Image Information and Television Engineers (e.g., “Three-Dimensional Shape Measurement Camera ˜Example of Implementation of High-Performance Three-Dimensional Shape Measurement System Using Smart Image Sensor˜” in journal of Institute of Image Information and Television Engineers, Vol. 66, No. 3, pp. 204-208 (2012)). It is to be noted that the light-section method used by the surface unevenness measure 151 is not limited to this method. The surface unevenness measure 151 may use a method other than the light-section method to measure the surface unevenness of the object T, as a matter of course. Data of the surface unevenness measured by the surface unevenness measure 151 is transmitted to the calculation section 162.

### (Calculation Section)

The calculation section 162 includes a surface roughness calculation part 162a. The surface roughness calculation part 162a calculates a surface roughness factor of the object T on the basis of measurement results (surface unevenness data) of the surface unevenness measure 151. The surface roughness factor is a surface roughness parameter indicating surface roughness of an object. In the example of the condition D3 in FIG. 6, the surface roughness calculation part 162a may calculate a surface roughness factor for each line, and set a mean thereof as a surface roughness factor (surface roughness parameter) within a measurement range.

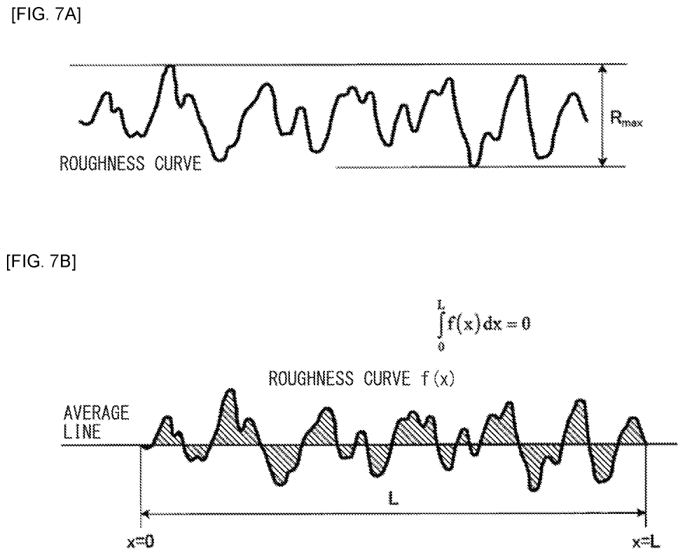

FIG. 7A is an explanatory diagram of a calculation example of the surface roughness factor. A roughness curve illustrated in FIG. 7A illustrates data of surface unevenness for one line. The surface roughness calculation part 162a may acquire maximum height Rₘₐₓ of the roughness curve, for example, as a surface roughness factor for one line. In this case, the surface roughness calculation part 162a may acquire a mean value of the maximum heights Rₘₐₓ for the respective lines, for example, as the surface roughness factor of the measurement range.

FIG. 7B is an explanatory diagram of another calculation example of the surface roughness factor. A roughness curve f(x) in FIG. 7B illustrates surface unevenness data for one line. The roughness curve f(x) satisfies the following expression (1). The surface roughness calculation part 162a may set arithmetic mean roughness calculated from the roughness curve f(x) as the surface roughness factor for one line.

[Numerical Expression 1]

∫₀^{L}ƒ(x)dx=0 (1)

It is to be noted that the arithmetic mean roughness may be center line mean roughness Rₐ calculated by the following expression (2). In this case, the surface roughness calculation part 162a may acquire a mean value of the center line mean roughness Rₐ of the respective lines as the surface roughness factor of the measurement range.

$$\begin{matrix}[ Numerical Expression 2 ] & \\ {R}_{a} = \frac{1}{L} {\int }_{0}^{L} \vert f ( x ) \vert dx & ( 2 )\end{matrix}$$

In addition, the arithmetic mean roughness may be root-mean-square roughness R_{q} calculated by the following expression (3). In this case, the surface roughness calculation part 162a may acquire a mean value of the root-mean-square roughness R_{q} of the respective lines as the surface roughness factor of the measurement range.

$$\begin{matrix}[ Numerical Expression 3 ] & \\ {R}_{q} = \sqrt{\frac{1}{L} {\int }_{0}^{L} {f ( x )}^{2} d x} & ( 3 )\end{matrix}$$

### (Determination Section)

Returning to FIG. 5, the image captured by the camera 152 is transmitted to the determination section 163. On the basis of the image captured by the camera 152, the determination section 163 determines what the captured object T is, what the material of the object T is, and whether the measurement condition of the measurement unit 15 is appropriate. As described above, the determination section 163 includes the subject determination part 163a, the material determination part 163b, and the measurement condition determination part 163c.

The subject determination part 163a determines the aspect of the object T. For example, the subject determination part 163a determines what the object T is (e.g., whether a tea bowl, or a stuffed toy, etc.) on the basis of the image captured by the camera 152. For example, the subject determination part 163a may input the image captured by the camera 152 to a learning model having learned a relationship between the image and the type of the object to thereby determine what the object T is. Here, the learning model may be a model based on a neural network such as CNN (Convolutional Neural Network). Examples of the method of determination include a method provided in CVPR (e.g., CVPR2014, “Rich feature hierarchies for accurate object detection and semantic segmentation”). It is to be noted that the determination method to be used by the subject determination part 163a is not limited to this method. The subject determination part 163a may use a method other than the method using the learning model to determine the type of the object T, as a matter of course.

The material determination part 163b determines the aspect of the object T. For example, on the basis of the image captured by the camera 152, the subject determination part 163a determines what the material (material quality) of the object T is (e.g., whether wood, pottery, plastic, soil, or cloth, etc.). For example, the material determination part 163b inputs the image captured by the camera 152 to the learning model having learned the relationship between the image and the material of the object to thereby determine what the material of the object T is. Here, the learning model may be a model based on a neural network such as the CNN. Examples of the method of determination include a method published by researchers of Drexel University (e.g., https://arxiv.org/pdf/1611.09394.pdf, “Material Recognition from Local Appearance in Global Context”). It is to be noted that the determination method to be used by the material determination part 163b is not limited to this method. The material determination part 163b may use a method other than the method using the learning model to determine a material of the object T, as a matter of course.

The measurement condition determination part 163c determines a measurement condition of the object T. That is, the measurement condition determination part 163c determines whether the measurement unit 15 measures the object T in an appropriate condition. As an instance, the measurement condition determination part 163c determines whether or not the object T has been measured under brightness that satisfies a predetermined standard. For example, the imaging condition of the object T makes it possible to determine whether or not the object T has been measured under the brightness that satisfies the predetermined standard. For example, the measurement condition determination part 163c calculates brightness of the entire image captured by the camera 152 (or brightness of the measurement range within the image). The brightness may be a mean of luminance values of respective pixels. Then, the measurement condition determination part 163c determines, when the brightness of the image is brighter than a threshold value, that the measurement by the measurement unit 15 is measurement under an appropriate condition, and determines, when the brightness is equal to or less than the threshold value, that the measurement is not measurement under the appropriate condition.

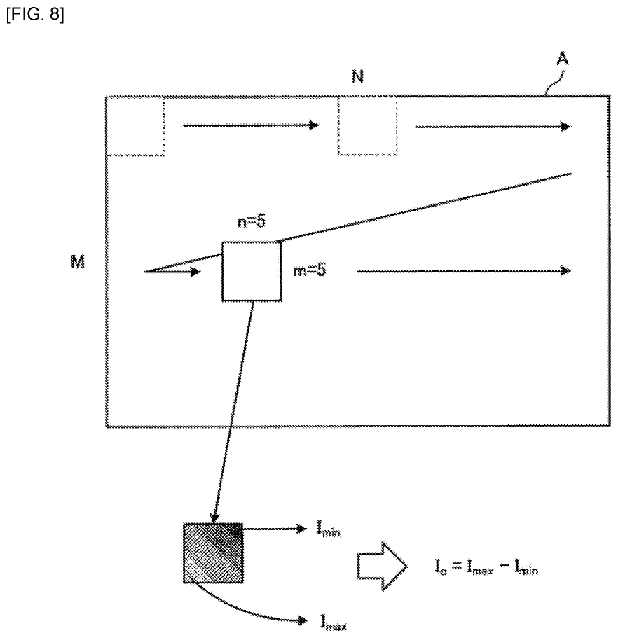

In addition, the measurement condition determination part 163c may calculate contrast of the image (or a predetermined measurement range within the image) captured by the camera 152, and may determine that the measurement by the measurement unit 15 is measurement under the appropriate condition when the contrast is higher than a threshold value. FIG. 8 is an explanatory diagram of contrast calculation processing. Specifically, FIG. 8 illustrates an example of calculation of the contrast. Here, the measurement range A may be the same as the measurement range A illustrated in the condition D2 in FIG. 6, or may be the entire image illustrated in the condition D1 in FIG. 6. In the example of FIG. 8, the measurement range A is an image region having a size of M×N pixels. The measurement condition determination part 163c determines, for example, contrast in the region of m×n pixels (e.g., m=5 and n=5) within an M×N region. At this time, the measurement condition determination part 163c may acquire, as a contrast I_{c} of the m×n region, a difference between a maximum luminance value Iₘₐₓ and a minimum luminance value Iₘᵢₙ within the m×n region. The measurement condition determination part 163c scans, within the M×N region, the m×n region to acquire the contrast I_{c} of the m×n region in the entire M×N region. Then, the measurement condition determination part 163c acquires a mean value of the contrast I_{c} as the contrast of the M×N region. The contrast of the M×N region is able to be calculated, for example, by the following expression (4).

$$\begin{matrix}[ Numerical Expression 4 ] & \\ {\tilde{I}}_{C} = \frac{1}{( M - m + 1 ) ( N - n + 1 )} {\sum }_{k = 1}^{( M - m + 1 ) ( N - n + 1 )} Ic & ( 4 )\end{matrix}$$

When the contrast of the M×N region is higher than a predetermined threshold value, the measurement condition determination part 163c determines the measurement to be appropriate measurement. It is to be noted that the scanning may be performed only in the measurement range A, or may be performed in the entire image.

In addition, the measurement condition determination part 163c may determine whether or not a distance between the measurement unit 15 and the object T is appropriate. At this time, the measurement unit 15 to be a target of determination of the measurement condition may be the surface unevenness measure 151 or the camera 152. When the measurement unit 15 includes a measure other than the surface unevenness measure 151 and the camera 152, the measurement unit 15 to be a target of the determination of the measurement condition may be a measure other than the surface unevenness measure 151 and the camera 152.

For example, suppose that the measurement unit 15 includes a distance sensor, such as a ToF sensor, in addition to the surface unevenness measure 151 and the camera 152. In this case, the measurement condition determination part 163c seeks a mean d of distances within the measurement range A on the basis of information from the distance sensor, and, when the mean d is within a predetermined range (dₘᵢₙ<d<dₘₐₓ), determines that the measurement is performed in an appropriate condition. Taking into consideration noise levels corresponding to the respective distances measured by the distance-measuring sensor and size of surface unevenness to be measured, dₘᵢₙ and dₘₐₓ are each decided to allow the noise level to be smaller than the size of the surface unevenness. It is to be noted that the distance to the object T may not necessarily be acquired using the distance sensor. For example, when the camera 152 is a stereo camera, it is possible to measure the distance to the object T using parallax.

### (Selection Section)

The selection section 164 selects an estimation scheme to be used by the estimation section 165 on the basis of determination results of the determination section 163. For example, the selection section 164 selects an estimation scheme to be used by the estimation section 165 from among a plurality of estimation schemes on the basis of determination results of the measurement condition determination part 163c. For example, in a case where determination is made that the measurement is performed appropriately, the selection section 164 selects an estimation scheme that is accurate and has a low arithmetic cost (e.g., a calibration curve scheme described later) as the estimation scheme to be used by the estimation section 165. Meanwhile, in a case where determination is made that the measurement is not performed appropriately, the selection section 164 selects an estimation scheme that has a high arithmetic cost but is accurate to a certain degree regardless of the quality of measured data (e.g., a machine learning scheme described later) as the estimation scheme to be used by the estimation section 165.

For example, as for the selection section 164, in a case where the distance to the object T satisfies a predetermined standard, an amount of noise included in the measured data of the surface unevenness measure 151 (first measure) is assumed to be a certain amount or less, and thus the measurement results of the surface unevenness measure 151 are reliable. Therefore, in a case where the distance to the object T satisfies the predetermined standard, the selection section 164 selects a first estimation scheme (e.g., a calibration curve learning scheme) that uses the measurement results of the surface unevenness measure 151 as the estimation scheme to be used by the estimation section 165.

Meanwhile, in a case where the distance to the object T does not satisfy the predetermined standard, the amount of noise included in the measured data of the surface unevenness measure 151 is assumed to be large, and thus the measurement results of the surface unevenness measure 151 (first measure) are unreliable. Therefore, in a case where the distance to the object T satisfies the predetermined standard, the selection section 164 selects, as the estimation scheme to be used by the estimation section 165, a second estimation scheme (e.g., machine learning scheme) that does not use the measurement results of the surface unevenness measure 151. This enables the estimation apparatus 10 to estimate a contact sense of the object T, even when the distance between the object T and the measurement unit 15 is large.

It is to be noted that the selection section 164 may select an estimation scheme on the basis of determination results of the imaging condition (brightness or contrast) of the object T. For example, in a case where the imaging condition of the object T satisfies a predetermined standard, the surface unevenness measure 151 is assumed to have measured the surface unevenness of the object T under an environment where shading is likely to be generated on a surface of the object T, and thus the selection section 164 selects, as the estimation scheme to be used by the estimation section 165, the first estimation scheme (e.g., calibration curve learning scheme) using the measurement results of the surface unevenness measure 151. Meanwhile, in a case where the imaging condition to the object T does not satisfy the predetermined standard, the surface unevenness measure 151 is assumed to have measured the surface unevenness of the object T under an environment where determination on the shading is not able to be made well for the measurement of surface roughness, and thus the selection section 164 selects, as the estimation scheme to be used by the estimation section 165, the second estimation scheme (e.g., machine learning scheme) not using the measurement results of the surface unevenness measure 151.

It is to be noted that the selection section 164 may further finely select an estimation scheme on the basis of the determination results of the determination section 163. For example, on the basis of determination results of the subject determination part 163a and/or the material determination part 163b, the selection section 164 may select the estimation scheme to be used by the estimation section 165 from among a plurality of estimation schemes. For example, suppose that the calibration curve scheme is selected on the basis of the determination results of the measurement condition determination part 163c. In this case, the selection section 164 further selects a calibration curve corresponding to the type and/or material of the object T from among a plurality of calibration curves. Meanwhile, suppose that the machine learning scheme is selected on the basis of the determination results of the measurement condition determination part 163c. In this case, the selection section 164 further selects a learning model corresponding to the type and/or material of the object T from among the plurality of learning models. The selection of the calibration curve or the selection of the learning model may also be regarded as the selection of an estimation scheme.

It is to be noted that, in a case where determination is made that the measurement is not performed appropriately, the control unit 16 (e.g., the selection section 164 or the management section 166) may notify a user through the output unit 13 or the communication unit 11 that the measurement by the measurement unit 15 is not performed appropriately.

### (Estimation Section)

The estimation section 165 estimates the tactile sense of the object T in accordance with an estimation scheme selected by the selection section 164. For example, suppose that the calibration curve scheme is selected by the selection section 164. In this case, the estimation section 165 uses the estimation scheme (e.g., calibration curve scheme) selected by the selection section 164 to convert surface roughness information calculated by the calculation section 162 to tactile information. Meanwhile, suppose that the machine learning scheme is selected by the selection section 164. In this case, the estimation section 165 uses the estimation scheme (e.g., machine learning scheme) selected by the selection section to convert data of the image captured by the camera 152 or an image feature amount extracted from the image, to the tactile information. The tactile information is one type of the contact sense information.

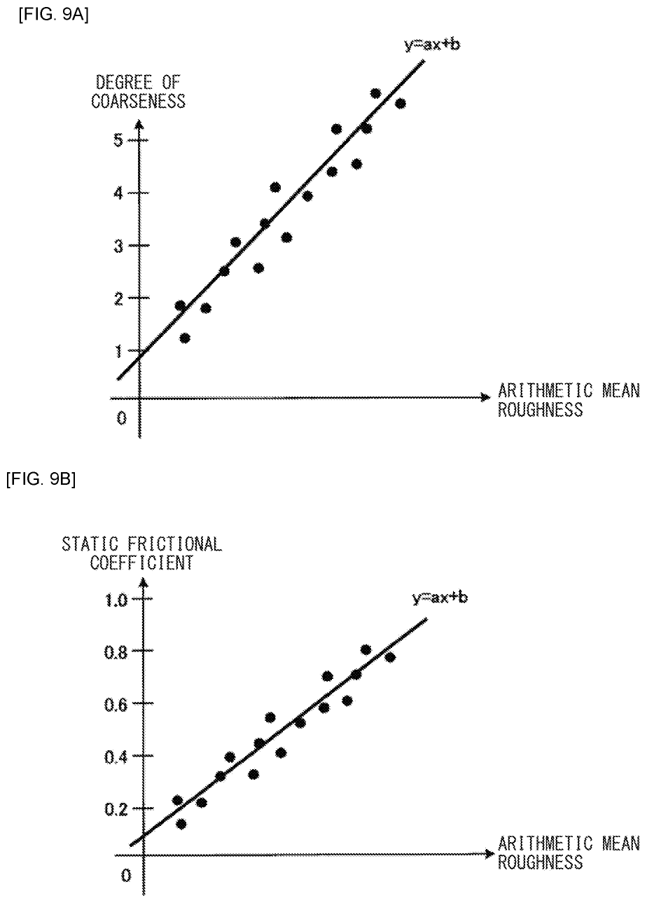

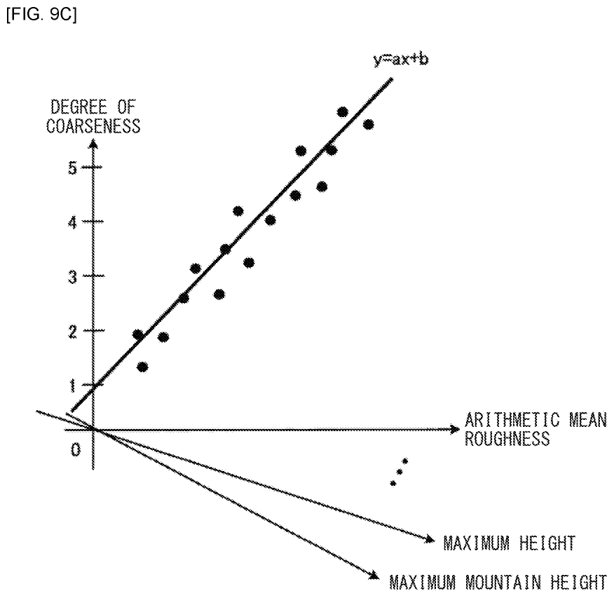

In the calibration curve scheme, the estimation section 165 substitutes the surface roughness information calculated by the calculation section 162 into the calibration curve to estimate the tactile sense of the object T. FIGS. 9A to 9C each illustrate an example of the calibration curve. A creator of the calibration curve creates a calibration curve in advance for each type and each material of an object. For example, the calibration curve is able to be created as follows. First, the creator of the calibration curve prepares samples of surface roughness (Rₘᵢₙ≤R≤Rₘₐₓ) for various materials. Then, the creator asks a plurality of examinees to make sensory evaluation of a degree of coarseness of the samples. Then, the creator creates a calibration curve on the basis of information on the sensory evaluation made by the plurality of examinees, for example, as illustrated in FIG. 9A.

The sensory evaluation is made, for example, as follows. Here, an example is given of evaluating the degree of coarseness of wood pieces. The number of examinees is set to 50. Then, the creator of the calibration curve prepares, as evaluation samples, about 20 types of wood pieces having various kinds of surface unevenness. Then, the creator asks the examinees to touch each of the samples and to evaluate the degree of coarseness in five levels. For example, the evaluation is asked to be made to have a degree of coarseness=0 at the time of being not coarse at all, a degree of coarseness=4 at the time of being very coarse, and so on. The creator of the calibration curve measures surface roughness information Ra on each of the evaluation samples in advance using the surface roughness measure such as an optical contactless measure. Then, the creator plots measured values and sensory evaluation values of the respective samples on a graph with the horizontal axis being set as the surface roughness and the vertical axis being set as the degree of coarseness, to thereby obtain a calibration curve y=ax+b. The creator similarly creates a calibration curve also for other tactile sensations (a degree of smoothness, a degree of silkiness, etc.). The creator may change the type of the sample to a fabric or the like to similarly evaluate the tactile sensation for each material quality.

It is to be noted that creator may use a frictional coefficient measured with a friction meter, instead of the sensory evaluation by the examinee, to prepare a calibration curve. In this case, the calibration curve becomes a calibration curve for calculation of a frictional coefficient from the surface roughness information as illustrated in FIG. 9B. The frictional coefficient is also one type of the tactile information.

In addition, the creator may create the calibration curve for calculation of the tactile information on the basis of a plurality of pieces of surface roughness information. FIG. 9C illustrates an example of a calibration curve for calculation of the tactile information on the basis of the plurality of pieces of surface roughness information. In the example of FIG. 9C, arithmetic mean roughness, maximum height, maximum mountain height, and the like are used as the surface roughness information.

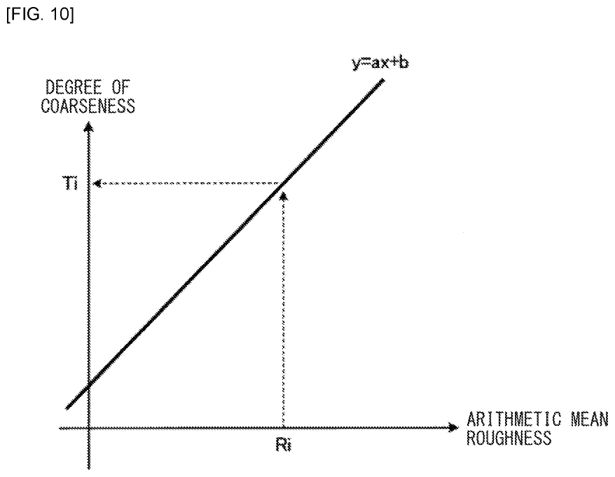

The estimation section 165 substitutes the surface roughness information into the calibration curves to thereby calculate the tactile information. FIG. 10 illustrates a state in which a calibration curve is used to calculate the tactile information. In the example of FIG. 10, the estimation section 165 inputs arithmetic mean roughness Ri to the calibration curve y=ax+b to thereby calculate a degree of coarseness Ti. That is, the calibration curve scheme is a scheme that converts the surface roughness information on the object T to the contact sense information on the basis of sensory evaluation information.

In the machine learning scheme, the estimation section 165 cuts out a measurement range from the image captured by the camera 152 and inputs the cut-out data to the learning model to thereby acquire tactile information. The learning model may be a model based on the CNN. In addition, the tactile information may be a frictional coefficient. Examples of the machine learning scheme include a method published by Information Processing Society of Japan (e.g., “Estimation of static friction coefficient using captured images”, Information Processing Society of Japan, 78th national convention).

It is to be noted that, when only image data is employed as data to be inputted to the learning model, there is a possibility that a nearby small shape and a distant large shape may be regarded as the same. However, it is possible to avoid this issue by inputting, to the learning model, distance information measured by the light-section method, the distance sensor, or the like, together, in addition to the image data.

### (Management Section)

The management section 166 stores, in the storage unit 14, the tactile information obtained by the estimation section 165. The management section 166 may manage the data by applying encryption processing to the data or using a blockchain to prevent unauthorized changes to the tactile information. The stored tactile information may be utilized to represent a commodity status when conducting electronic commerce transaction. The management section 166 stores and manages, not only the tactile information, but also the image data and the surface unevenness data obtained by the measurement unit 15, the “surface roughness factor” obtained by the calculation section 162, “subject information”, “material information” and the “estimation condition” obtained by the determination section 163, and the “estimation scheme” selected by the selection section 164.

In addition, the management section 166 may convert the data stored in the storage unit 14 to return the converted data in response to an inquiry form the outside. For example, in a case where the tactile information (e.g., degree of coarseness) stored in the storage unit 14 has five levels (1, 2, 3, 4, and 5), the management section 166 may multiply a coefficient (e.g., 20) to return the value when information of 100 levels is requested from an inquiry source. In addition, in a case of receiving an inquiry about image data, the management section 166 may add Gaussian noise to the image in response to the degree of coarseness corresponding to the image to produce a feeling of coarseness, and then may return the image. For example, when a luminance range of the image is in a range of from 0 to 255, the management section 166 may add, to the image, Gaussian noise of, for example, σ=10 in the case where the degree of coarseness is 1, σ=15 in the case where the degree of coarseness is 2, σ=20 in the case where the degree of coarseness is 3, σ=25 in the case where the degree of coarseness is 4, and σ=30 in the case where the degree of coarseness is 5.

### <2-2. Operation of Estimation Apparatus>

Next, description is given of an operation of the estimation apparatus 10.

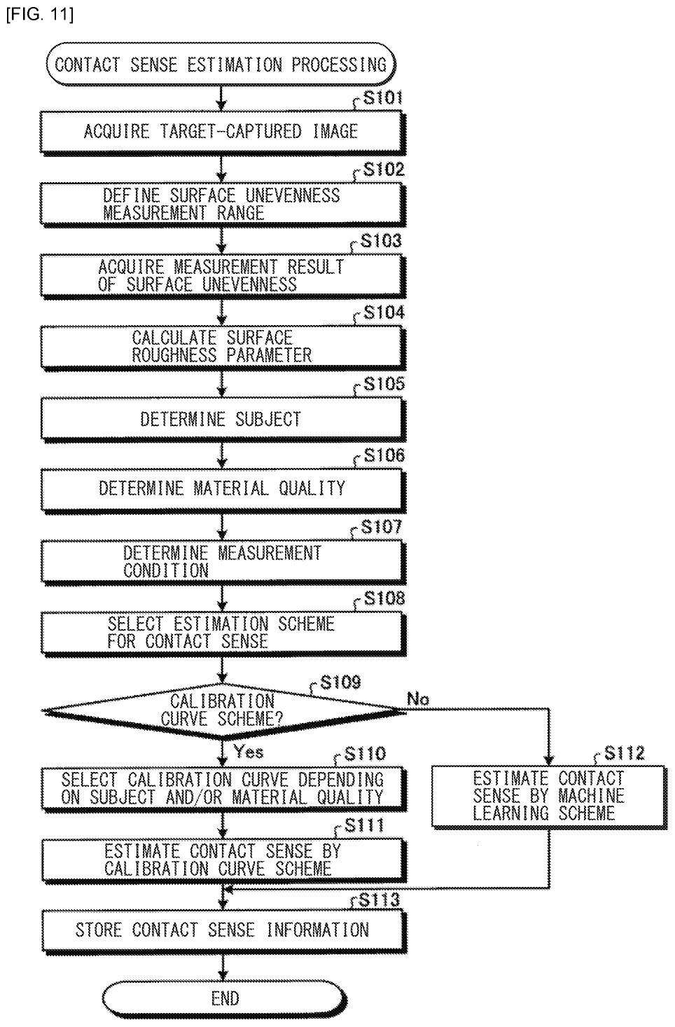

FIG. 11 is a flowchart illustrating contact sense estimation processing according to Embodiment 1. The contact sense estimation processing is processing for contactless estimation of the contact sense of the object T to be an estimation target of the contact sense. The contact sense to be estimated by the contact sense estimation processing may be the tactile sense, or may be the force sense. The contact sense may be each of the tactile sense and the force sense, or may be another sense, as a matter of course. The estimation apparatus 10 starts the contact sense estimation processing upon receiving a command from a user via the communication unit 11 or the input unit 12, for example.

First, the acquisition section 161 of the estimation apparatus 10 acquires an image captured by the camera 152 (step S101). Then, the acquisition section 161 acquires information concerning a measurement range of the object T from the user via the communication unit 11 or the input unit 12, and defines the measurement range A of the object T on the basis of the acquired information (step S102). Further, the acquisition section 161 of the estimation apparatus 10 acquires measurement results (measured data) of the measurement range A from the surface unevenness measure 151 (step S103).

Next, the calculation section 162 of the estimation apparatus 10 calculates a surface roughness parameter (surface roughness factor) of the object T on the basis of the measured data acquired in step S103 (step S104). The surface roughness parameter may be the arithmetic mean roughness calculated from the measured data. At this time, the arithmetic mean roughness may be a value calculated by averaging the maximum heights Rₘₐₓ of a plurality of roughness curves. In addition, the arithmetic mean roughness may be the center line mean roughness Rₐ of the roughness curve or a value calculated on the basis of the center line mean roughness Rₐ. In addition, the arithmetic mean roughness may be the root-mean-square roughness R_{q} of the roughness curve or a value calculated on the basis of the root-mean-square roughness R_{q}.

Subsequently, the determination section 163 of the estimation apparatus 10 determines the type of the object T, i.e., what the subject is, on the basis of the image captured by the camera 152 (step S105). In addition, the determination section 163 determines the material quality of the object T on the basis of the image captured by the camera 152 (step S106). Further, the determination section 163 determines the measurement condition of the object T by the measurement unit 15 (step S107). At this time, the determination section 163 may determine the measurement condition of the object T on the basis of the image captured by the camera 152, or may determine the measurement condition of the object T on the basis of measurement results of another sensor (e.g., distance sensor). The measurement condition may be whether or not the brightness of the image satisfies the standard, or may be whether or not the distance to the object T satisfies the standard.

Subsequently, the selection section 164 of the estimation apparatus 10 selects, from among a plurality of estimation schemes, an estimation scheme to be used for the estimation of the contact sense of the object T by the estimation apparatus 10, on the basis of the determination results of the determination section 163 (step S108). For example, the selection section 164 selects, on the basis of determination results in step S107, whether the estimation apparatus 10 uses the calibration curve scheme to estimate the contact sense of the object T, or the estimation apparatus 10 uses the machine learning scheme to estimate the contact sense of the object T.

Subsequently, the estimation section 165 of the estimation apparatus 10 determines whether or not the calibration curve scheme is selected by the selection section 164 (step S109). In a case where the calibration curve scheme is selected (step S109: Yes), the selection section 164 selects a calibration curve corresponding to the type and/or material of the object T from among a plurality of calibration curves on the basis of determination results in step S105 and/or step S106 (step S110). The selection of the calibration curve may also be regarded as the selection of an estimation scheme. The estimation section 165 uses the selected calibration curve to estimate the contact sense of the object T (step S111).

Meanwhile, in a case where the machine learning scheme is selected (step S109: No), the estimation section 165 estimates the contact sense of the object T using the machine learning scheme (step S112). At this time, the learning model to be used for the estimation of the contact sense may be selected from among a plurality of learning models on the basis of the determination results in step S105 and/or step S106. The selection of the learning model may also be regarded as the selection of an estimation scheme.

The management section 166 of the estimation apparatus 10 stores, in the storage unit 14, the contact sense information generated in the processing of step S111 or step S112 (step S113). Upon completion of the storage, the estimation apparatus 10 finishes the contact sense estimation processing.

According to the present embodiment, the estimation apparatus 10 uses an optimum estimation scheme corresponding to an aspect of an object or a measurement condition of the object to estimate a contact sense of the object T. For example, the estimation apparatus 10 estimates the contact sense of the object T using the machine learning scheme, which is accurate to a certain degree regardless of the quality of measured data, in a case where measured data of surface roughness is unreliable, such as a case where it is assumed that the measured data of surface roughness includes a considerable amount of noise due to large distance to the object T, or a case where it is assumed that determination on shading is not able to be made well for the measurement of the surface roughness due to dark image. Meanwhile, in a case where the measured data of the surface roughness is reliable, the contact sense of the object T is estimated using the calibration curve scheme that is accurate and has a low arithmetic cost. This enables the estimation apparatus 10 to accurately estimate the contact sense of the object T in a contactless manner, regardless of the aspect or the measurement condition of the object T.

### 3. Embodiment 2 (Electronic Commerce Transaction)

Next, description is given of an estimation system 1 according to Embodiment 2. The estimation system 1 is, for example, a system for electronic commerce transaction. The estimation system 1 provides the contact sense information (e.g., tactile sensation information or force sense information) on a commodity to a user who conducts the electronic commerce transaction, for example. The user, for example, purchases a commodity by referring to the contact sense information on commodities in addition to information such as commodity prices and sizes.

### <3-1. Configuration of Estimation System>

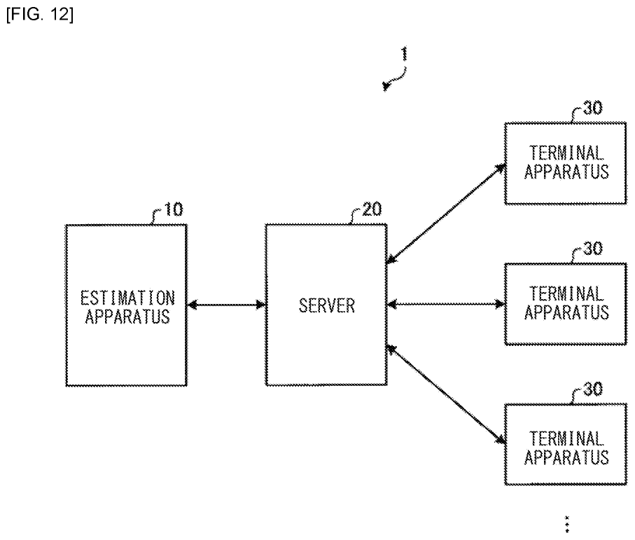

First, description is given of a configuration of the estimation system 1. FIG. 12 illustrates a configuration example of the estimation system 1 according to Embodiment 2. The estimation system 1 includes the estimation apparatus 10, a server 20, and a plurality of terminal apparatuses 30. It is to be noted that, although the estimation apparatus 10 and the server 20 are separate apparatuses in the example of FIG. 12, the estimation apparatus 10 and the server 20 may be integrated as an apparatus. The estimation apparatus 10 and the server 20 may be separate apparatuses, as a matter of course.

### (Estimation Apparatus)

The estimation apparatus 10 is an apparatus for estimation of the contact sense of a commodity. The contact sense to be estimated by the estimation apparatus 10 is the tactile sense, for example. The contact sense to be estimated by the estimation apparatus 10 may be the force sense, as a matter of course. The configuration of the estimation apparatus 10 is similar to that of the estimation apparatus 10 of Embodiment 1 illustrated in FIG. 1.

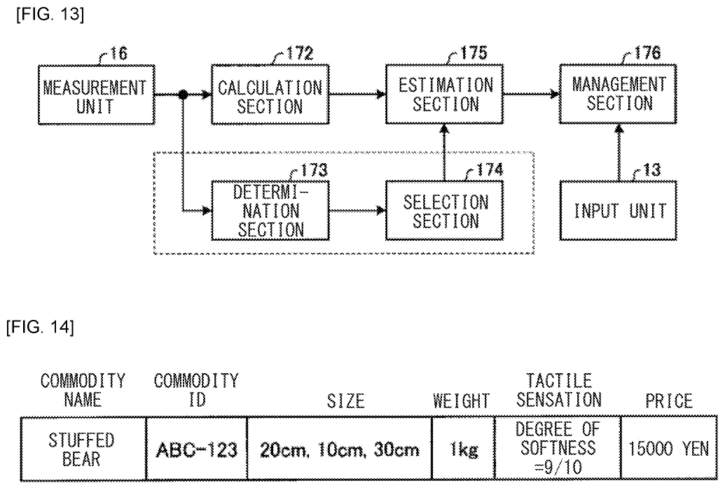

FIG. 13 illustrates relationships among blocks included in the estimation apparatus 10. The relationships among the blocks included in the estimation apparatus 10 are substantially the same as the relationships among the blocks included in the estimation apparatus 10 of Embodiment 1; however, in Embodiment 2, the management section 166 is able to acquire commodity information via the input unit 12. For example, the commodity information is inputted to the estimation apparatus 10 by a provider of commodities or commodity information (hereinafter, simply referred to as a provider) using the input unit 12. The commodity information is information concerning commodities, e.g., the size and weight of commodities. The information may be acquired by a person measuring dimensions of length, width and height of a commodity with a ruler and weighing the commodity with a scale.

The management section 166 stores, in the storage unit 14, the commodity information inputted from the input unit 12 together with the contact sense information on the commodity estimated by the estimation section 165. The management section 166 may transmit the commodity information to the server 20 via the communication unit 11. In addition, the management section 166 may transmit the commodity information to the terminal apparatus 30 via the server 20.

FIG. 14 illustrates an example of the commodity information. The commodity information includes commodity name, commodity ID, size, weight, price, and the like, as well as information on the tactile sensation of the commodity. In the example of FIG. 14, the commodity name is “stuffed bear”; the commodity ID is “ABC-123”; the size is “20 cm, 10 cm, and 30 cm”; the weight is “1 kg”; and the price is “15000 yen”. In the example of FIG. 14, the commodity information includes a “degree of softness” as the information on the tactile sensation of the commodity. In the example of FIG. 14, the degree of softness is 9 in 10-level evaluation. The degree of softness is the contact sense information on the commodity estimated by the estimation section 165.

### (Server)

The server 20 is a server host computer that provides various services to a client terminal such as the terminal apparatus 30. For example, the server 20 is a server that provides an electronic commerce transaction service to a user operating the terminal apparatus 30. For example, the server 20 is a shopping server (EC (Electronic Commerce) server) that functions as a shopping site (e.g., an EC site). In response to a request from the terminal apparatus 30, the server 20 performs processing related to browsing of commodities, processing related to settlement for commodity purchases, processing related to ordering of commodities, and the like.

It is to be noted that the services provided by the server 20 are not limited to the shopping service. For example, the service provided by the server 20 may be an auction service. In this case, the server 20 may be an auction server functioning as an auction site. The auction service may also be regarded as one type of the electronic commerce transaction service. The auction service may be rephrased as a flea market service, or the like.

It is to be noted that the service provided by the server 20 may be a service other than the electronic commerce transaction service. For example, the service provided by the server 20 may be a commodity comparison service for users to compare the commodity information (e.g., commodity price). Alternatively, the server 20 may provide other services that involve delivering the commodity information.

It is to be noted that functions of the server 20 may be implemented discretely in a plurality of physically separate apparatuses. In this case, one or a plurality of the plurality of apparatuses may have a function as the estimation apparatus 10.

### (Terminal Apparatus)

The terminal apparatus 30 is a user terminal to be operated by a user who utilizes a service such as the electronic commerce transaction service. For example, the terminal apparatus 30 may be an information processing terminal such as a smart device (a smartphone, or a tablet), a mobile phone, or a personal computer. The user has a web browser or an application (e.g., a shopping application or a flea market application), which is installed in the terminal apparatus 30, to access a site provided by the server 20. The user operating the terminal apparatus 30 operates the web browser or the application to acquire the commodity information from the server 20.

### <3-2. Operation of Estimation System>

Next, description is given of an operation of the estimation system 1.

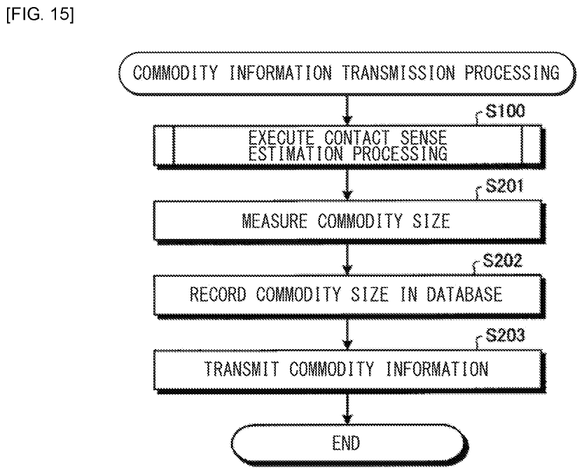

FIG. 15 is a flowchart illustrating commodity information transmission processing according to Embodiment 2. The commodity information transmission processing is processing for transmission of the commodity information including the contact sense information to other apparatuses (e.g., server 20 and terminal apparatus 30). The estimation apparatus 10 starts the contact sense estimation processing upon receiving a command from a provider of commodities, or the like via the communication unit 11 or the input unit 12, for example.

First, the control unit 16 of the estimation apparatus 10 executes the contact sense estimation processing (step S100). The contact sense estimation processing is processing for contactless estimation of the contact sense of the object T to be a transmission target of the commodity information. The contact sense estimation processing may be similar to the contact sense estimation processing of Embodiment 1.

Subsequently, the control unit 16 of the estimation apparatus 10 measures size of the object T as a commodity (step S201). The size of the object T may be determined on the basis of measurement results of the measurement unit 15 (e.g., image captured by the camera 152 or information on a distance to the object T). In addition, the size of the object T may be measured by the estimation apparatus 10 controlling a 3D scanner apparatus. In this case, the measurement unit 15 of the estimation apparatus 10 may include the 3D scanner apparatus. The control unit 16 may use information received from the provider via the communication unit 11 or the input unit 12, as it is, as the commodity information, as a matter of course.

Subsequently, the management section 166 of the estimation apparatus 10 records the commodity size in a database inside the storage unit 14 (step S202). Then, the management section 166 transmits the commodity information such as the commodity size to the server 20 (step S203). At this time, the management section 166 also causes the contact sense information acquired in step S100 to be included in the commodity information. Upon receiving the commodity information, the server 20 registers the commodity information in a commodity database managed by the server 20. It is to be noted that, in a case where the server 20 functions as the estimation apparatus 10, the management section 166 may transmit the commodity information to the terminal apparatus 30 in this step. Upon completion of the transmission of the commodity information, the estimation apparatus 10 finishes the commodity information transmission processing.

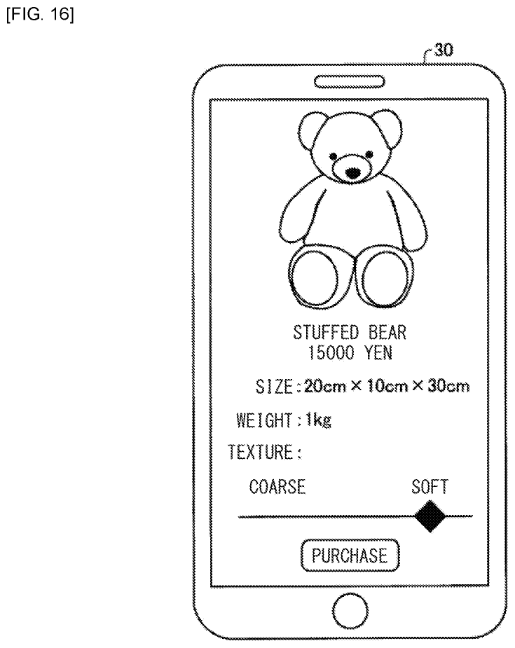

When information is requested from the terminal apparatus 30, the server 20 acquires commodity information (commodity photograph, price, size, texture, etc.) from the commodity database. Then, the server 20 processes the commodity information acquired from the commodity database into a format suitable for browsing, and transmits the processed commodity information to the terminal apparatus 30. FIG. 16 illustrates an example of the commodity information processed into the format suitable for browsing.

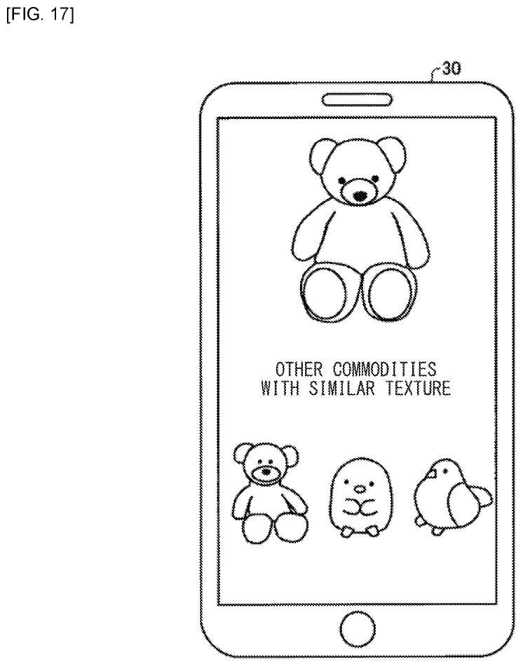

The server 20 may not only send information on a designated commodity designated by a user to the terminal apparatus 30, but also automatically search for similar commodities similar to the designated commodity to transmit information on the similar commodities to the terminal apparatus 30. FIG. 17 illustrates an example in which the information on the similar commodities is transmitted together with the information on the designated commodity. It is to be noted that the server 20 may evaluate the similarity among commodities on the basis of the information such as size, price, and texture. The similarity may be evaluated by the estimation section 165 or the management section 166 of the estimation apparatus 10. This enables the user to compare and examine the commodities having a similar texture, and thus to select and purchase a more preferable commodity.

The terminal apparatus 30 displays the commodity information having been sent from the server 20. After browsing the commodity information, the user selects a commodity and performs a purchasing procedure. Information on the procedure is sent to the server 20. On the basis of the information on the procedure, the server 20 performs settlement processing, processing related to commodity dispatch, and the like.

According to the present embodiment, it is possible for the user to obtain the contact sense information on commodities, and thus to make an optimum selection concerning purchasing of a commodity, or the like.

It is to be noted that using a special force transmission apparatus also enables the tactile sensation information to be provided to the user. However, this requires the user to prepare the special force transmission apparatus by him or herself, thus making it difficult to make selection, order, or the like of a commodity easily. In the present embodiment, the estimation system 1 provides the contact sense information of a commodity as the information based on the sensory evaluation such as the “degree of softness”. Therefore, the user is able to intuitively understand the contact sense of the commodity only by the information displayed on the terminal apparatus 30 without the special force transmission apparatus. As a result, the user is able to make selection, order, or the like of the commodity easily.

### 4. Embodiment 3 (Robot Hand)

Next, description is given of the estimation apparatus 10 according to Embodiment 3. The estimation apparatus 10 of Embodiment 3 is an apparatus having a function of gripping an object, for example. The estimation apparatus 10 of Embodiment 3 is a robot having a robot hand (robot arm), for example. In Embodiment 3, contact sense information on a surface of a target object by a contactless sensor is used to control a gripping operation of the robot. In the following description, suppose that the object to be gripped is the object T similarly to Embodiment 1.

### <4-1. Configuration of Estimation Apparatus>

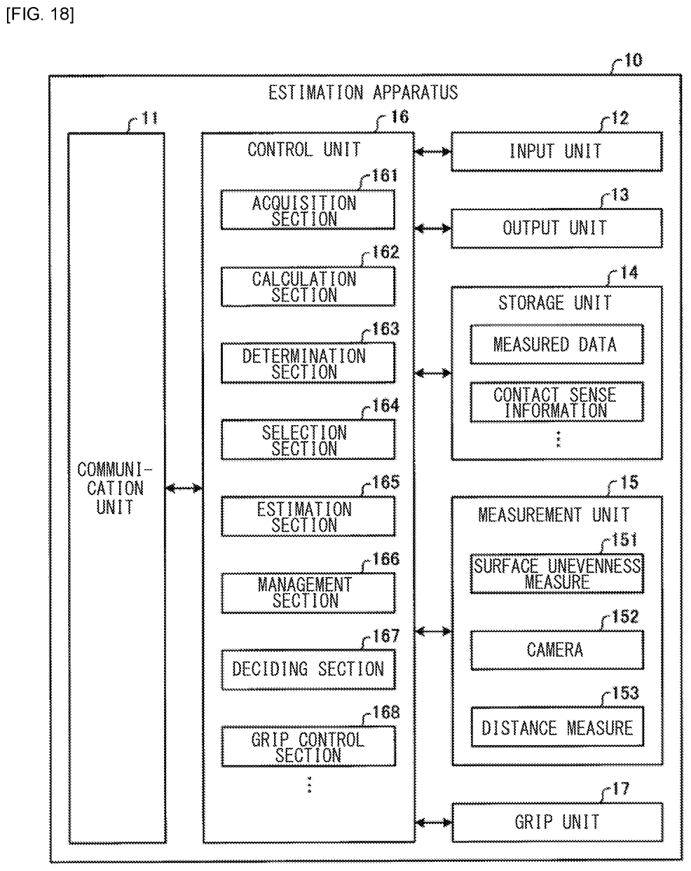

First, description is given of a configuration of the estimation apparatus 10. FIG. 18 illustrates a configuration example of the estimation apparatus 10 according to Embodiment 1. The estimation apparatus 10 includes the communication unit 11, the input unit 12, the output unit 13, the storage unit 14, the measurement unit 15, the control unit 16, and a grip unit 17. The configurations of the communication unit 11 to the storage unit 14 are similar to those of the estimation apparatus 10 of Embodiment 1.

The configuration of the measurement unit 15 is the same as that of the measurement unit 15 of Embodiment 1 except that a distance measure 153 is newly provided. The distance measure 153 is a distance sensor such as a ToF sensor, for example.

The configuration of the control unit 16 is the same as that of the control unit 16 of Embodiment 1 except that a deciding section 167 and a grip control section 168 are newly provided.

The grip unit 17 is a device having a function of gripping an object. The grip unit 17 is a robot hand (robot arm), for example.

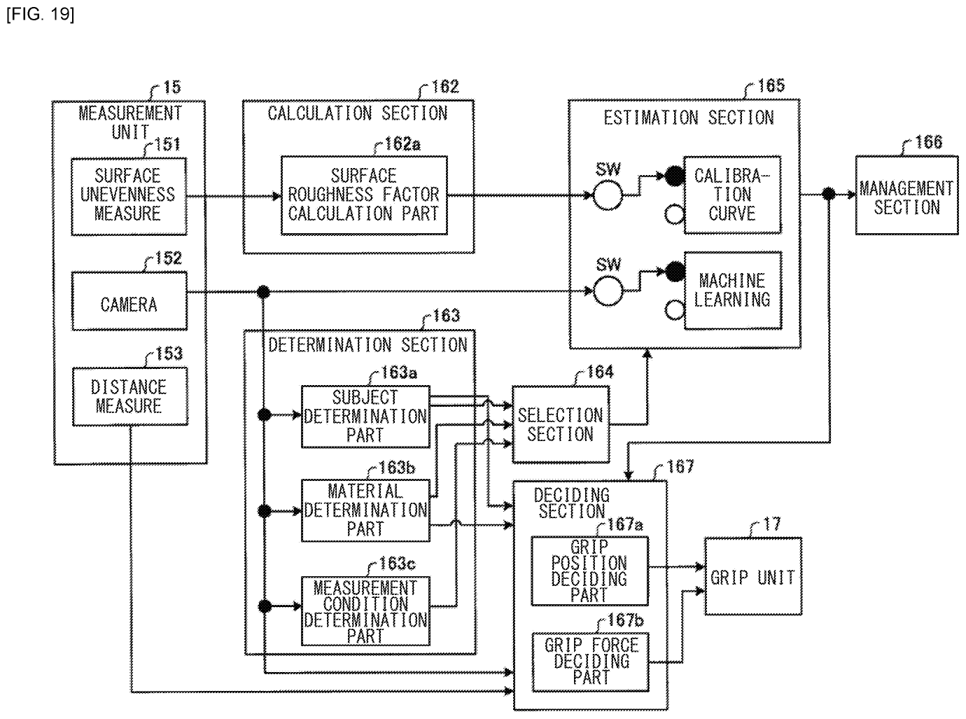

FIG. 19 illustrates in detail relationships among blocks included in the estimation apparatus 10.

The deciding section 167 decides a grip position and grip force of the object T. The deciding section 167 includes a grip position deciding part 167a and a grip force deciding part 167b.

The grip position deciding part 167a locates a position of the object T on the basis of measured data of the camera 152 and the distance measure 153, and decides a position to be gripped by the grip unit 17. Various methods may be used to decide the grip position. For example, the grip position deciding part 167a is able to locate the grip position from an image and distance information by using a report at Information Processing Society of Japan (e.g., “three-dimensional position orientation estimation using RGB-D camera for bin picking, and scoring method in consideration of graspability”, Information Processing Society of Japan, research report) and a method described in a paper by researchers of Chubu University (e.g., a “Grasping detection using deep convolutional neural network with graspability”).

The grip force deciding part 167b decides grip force on the basis of the contact sense (e.g., frictional coefficient) estimated by the estimation section 165. Various methods may be used to decide the grip position. For example, the grip force deciding part 167b is able to decide the grip force using the method described in PTL 2, “Gripping force control method of robot hand”. In addition, the grip force deciding part 167b may decide the grip force depending on the material quality of the object T determined by the material determination part 163b.

The grip control section 168 controls the grip unit 17 on the basis of the grip position and the grip force decided by the deciding section 167. The grip unit 17 grips the object T under the control of the grip control section 168.

### <4-2. Operation of Estimation Apparatus>

Next, description is given of an operation of the estimation apparatus 10.

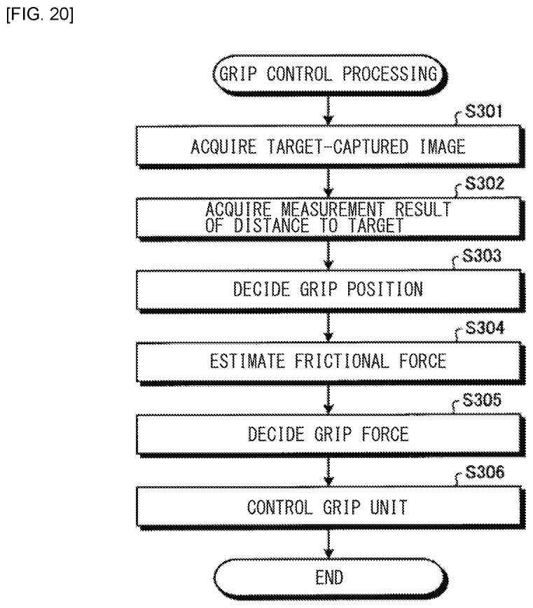

FIG. 20 is a flowchart illustrating grip control processing according to Embodiment 3. The grip control processing is processing for contactless estimation of the contact sense of the object T to be gripped and for gripping of the object T on the basis of the estimated contact sense. The contact sense to be estimated by the grip control processing may be the tactile sense, or may be the force sense. The contact sense may be each of the tactile sense and the force sense, or may be another sense, as a matter of course. In the present embodiment, the contact sense to be estimated in the grip control processing is the frictional force, but the contact sense is not limited to the frictional force. The estimation apparatus 10 starts the grip control processing upon receiving a command from a user via the communication unit 11 or the input unit 12, for example.

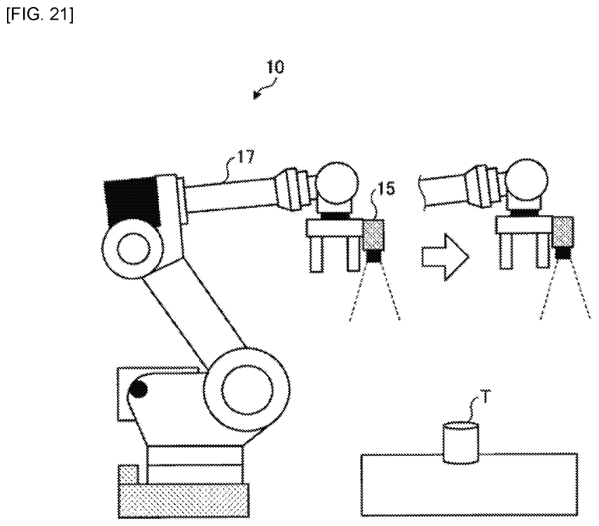

First, the acquisition section 161 of the estimation apparatus 10 acquires an image of the object T from the camera 152 (step S301). In addition, the acquisition section 161 of the estimation apparatus 10 acquires measurement results of a distance to the object T from the distance measure 153 (step S302). Then, the deciding section 167 decides a grip position on the basis of the image and the measurement result of the distance (step S303). FIG. 21 illustrates a state in which the estimation apparatus 10 decides a grip position.

The estimation section 165 estimates frictional force of a surface of the object T using the method described in Embodiment 1 (step S304). Then, the deciding section 167 decides grip force on the basis of the frictional force estimated by the estimation section 165 (step S305).

The grip control section 168 controls the grip unit 17 on the basis of the grip position and the grip force decided by the deciding section 167 (step S306). Upon completion of the control, the estimation apparatus 10 finishes the contact sense estimation processing.

According to the present embodiment, the estimation apparatus 10 estimates the frictional coefficient, the material quality, and the like of the object T, before actually gripping the object T with the grip unit 17, and performs the grip control on the basis of the estimation results, thus making it possible to prevent a failure such as destroying, dropping, or the like of the object T.

### 5. Embodiment 4 (Brace)

Existing braces such as a prosthetic arm and a prosthetic leg have been intended to feed back a sense of touching a target into a socket in a case where a user tries to touch the target actively (by him or herself). Originally, however, the brace such as a prosthetic arm or a prosthetic leg may be touched passively in some occasions. For example, a close person, such as a spouse, may touch the brace in some occasions with the intention of touching a body of the user wearing the brace. In this case, the person who touches the brace ends up touching the brace with the intention of touching the body of the user wearing the brace, and may possibly have an unpleasant feeling due to a gap with the sense of touching the body of the living body. In the present embodiment, an appropriate tactile sensation is fed back which causes no discomfort to the close person such as a spouse who even has touched the brace, by expressing aging of the user wearing the brace, environmental temperature, viscoelasticity, surface roughness, shear force generated between the object and the skin, and physical deformation deviating between layers of the skin. In addition, in the present embodiment, an appropriate tactile sensation, which causes no discomfort, is fed back in advance to a person who touches the brace.

The estimation apparatus 10 according to Embodiment 4 includes a device that presents a tactile sensation to a socket (cut surface) of a prosthetic arm and an exterior section corresponding to the skin, or the like. In addition, the estimation apparatus 10 presents elasticity and viscosity inside a target object by ultrasonic elastography to the person him or herself wearing a prosthetic arm and another person having touched the prosthetic arm.

### <5-1. Configuration of Estimation Apparatus>

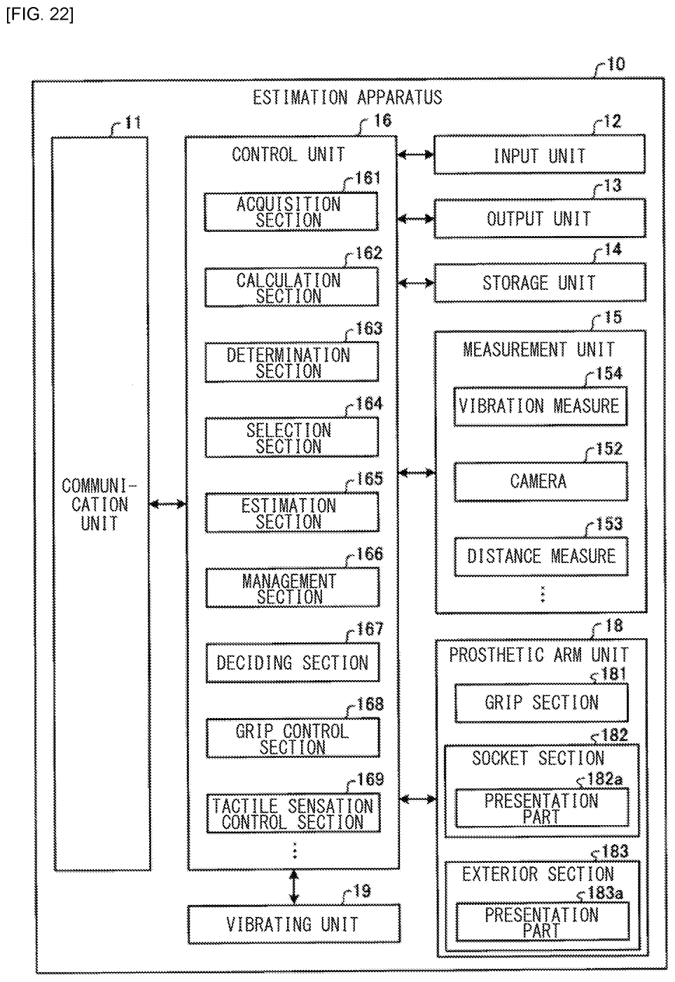

First, description is given of a configuration of the estimation apparatus 10. FIG. 22 illustrates a configuration example of the estimation apparatus 10 according to Embodiment 4. The estimation apparatus 10 includes the communication unit 11, the input unit 12, the output unit 13, the storage unit 14, the measurement unit 15, the control unit 16, the grip unit 17, and a vibrating unit 19. The configurations of the communication unit 11 to the measurement unit 15 are similar to those of the estimation apparatus 10 of Embodiment 3. The configuration of the measurement unit 15 is the same as that of the measurement unit 15 of Embodiment 2 except that a vibration measure 154 is newly provided. The configuration of the control unit 16 is the same as the control unit 16 of Embodiment 2 except that a tactile sensation control section 169 is newly provided.

A prosthetic arm unit 18 is a prosthetic arm worn by the user. The prosthetic arm unit 18 includes a grip section 181, a socket section 182, and an exterior section 183.

The socket section 182 is a part corresponding to a cut surface of the prosthetic arm unit 18. The socket section 182 includes a presentation part 182a. The presentation part 182a is a device that presents a tactile sensation of a person who touches the prosthetic arm unit 18 to the user who wears the prosthetic arm unit 18.

The exterior section 183 is a part corresponding to the skin of the prosthetic arm unit 18. The exterior section 183 includes the presentation part 182a. The presentation part 182a is a device that presents a tactile sensation resembling the skin of the user wearing the prosthetic arm to a person who passively touches the prosthetic arm unit 18.

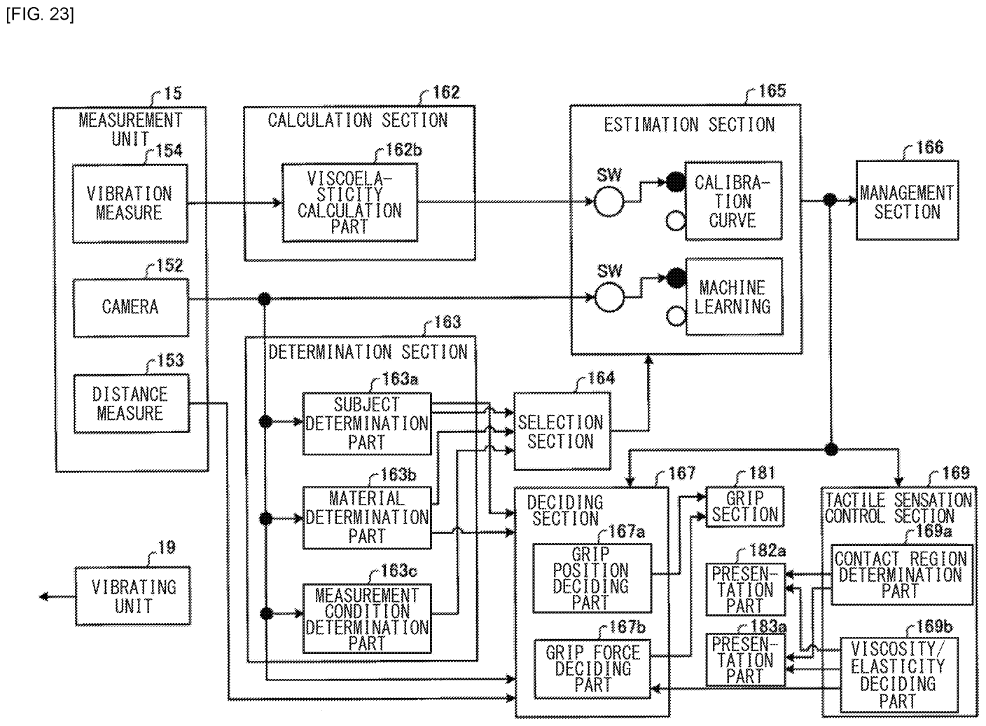

FIG. 23 illustrates in detail relationships among blocks included in the estimation apparatus 10.

Description is given of a physical vibrating unit and a vibration measurement section by referring to an example of ultrasonic elastography. The ultrasonic elastography is described, for example, in “Principle of ultrasonic elastography” in journal of Society of Biomechanisms Japan, Vol. 40, No. 2 (2016), and in “Principle of ultrasonic elastography by shear wave propagation” in MEDICAL IMAGING TECHOMOGY, Vol. 32, No. 2, March 2014.

The vibrating unit 19 is a device that vibrates the object T. The object T is, for example, the other arm (normal arm) of the user who wears the prosthetic arm. The vibrating unit 19 is configured by, for example, ultrasonic probe (TX), VCM (TX), VCM array (TX), or the like. The physical vibrating unit may be dispensed with in a case of utilizing a spontaneous vibration such as a pulse. In addition, vibration may be applied indirectly to the object T in conjunction with a smartphone or the like carried by a measurement target. It is to be noted that, it is not possible to utilize this method in a case where the position of a vibration source is not able to be grasped; therefore, the estimation apparatus 10 uses the vibration measure 154 to locate the vibration source, and performs arithmetic operation of the contact sense estimation.

The vibration measure 154 (a second measure) is a sensor that measures a vibration (e.g., shear wave) applied to the object T by the vibrating unit 19. The vibration measure 154 is configured by, for example, ultrasonic probe (RX), VCM (RX), VCM array (RX), or the like.

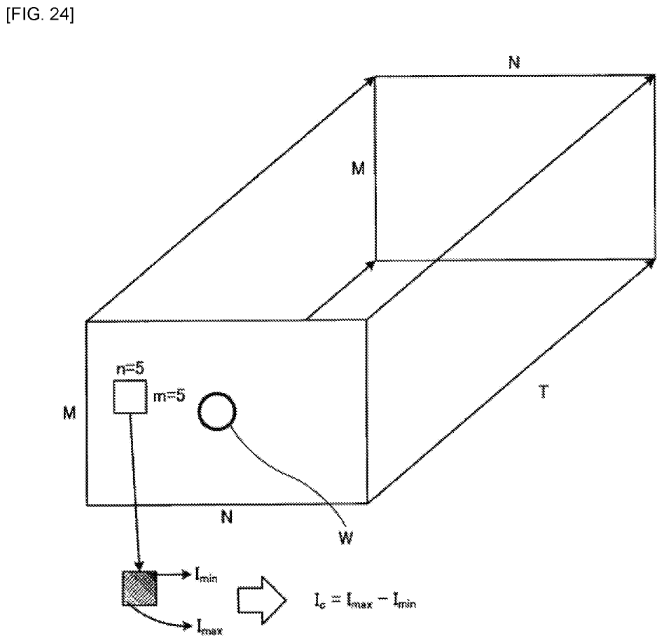

It is to be noted that the estimation apparatus 10 is able to measure a shear wave using the surface unevenness measure 151. FIG. 24 illustrates an example of measurement of shear (wave velocity) using the surface unevenness measure 151. In the example of FIG. 24, an ultrasonic wave is applied to a surface of the object T. The estimation apparatus 10 measures surface unevenness of the object T using the surface unevenness measure 151 (second measure). This enables the estimation apparatus 10 to measure a wave W generated on the surface of the object T by the ultrasonic wave. The estimation apparatus 10 accumulates measurement results of the wave W in a temporal direction. The estimation apparatus 10 is able to calculate a shear wave actually generated inside an object from a change in the wave W in the temporal direction.

The calculation section 162 includes a viscoelasticity calculation part 162b. The viscoelasticity calculation part 162b calculates viscoelastic information (e.g., shear elastic modulus and/or shear viscous modulus) of the object T on the basis of measurement results of the vibration measure 154. As a method of calculating the viscoelastic modulus, the method of ultrasonic elastography described above is usable.

The estimation section 165 converts the viscoelastic information calculated by the calculation section 162 to tactile information in accordance with the estimation scheme selected by the selection section 164.

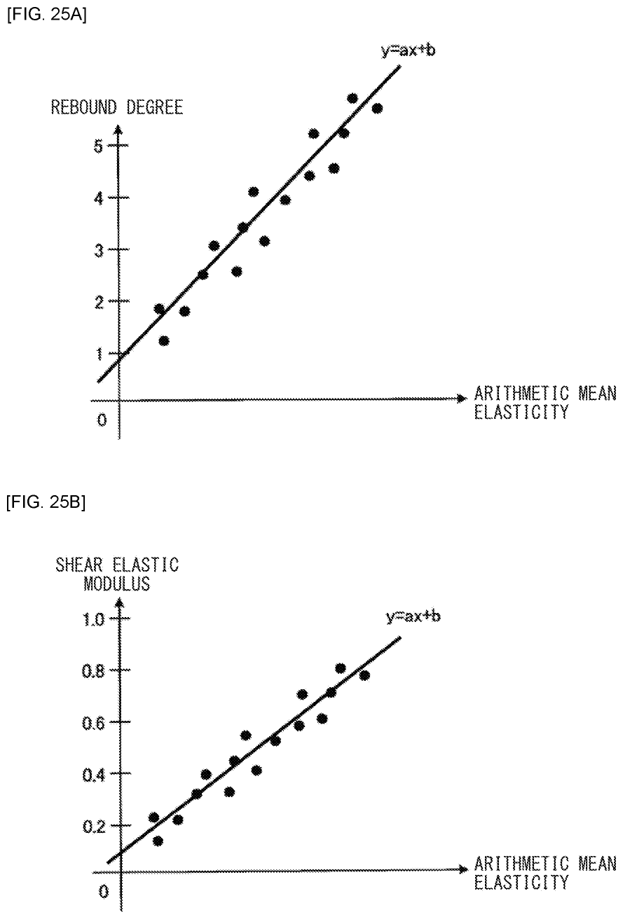

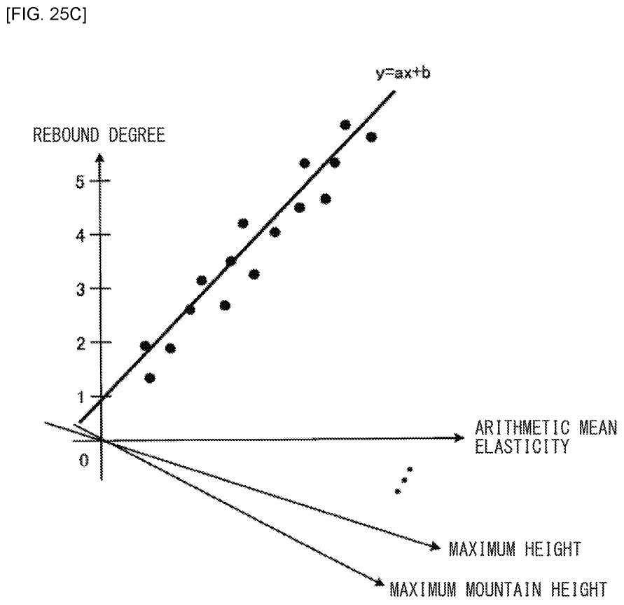

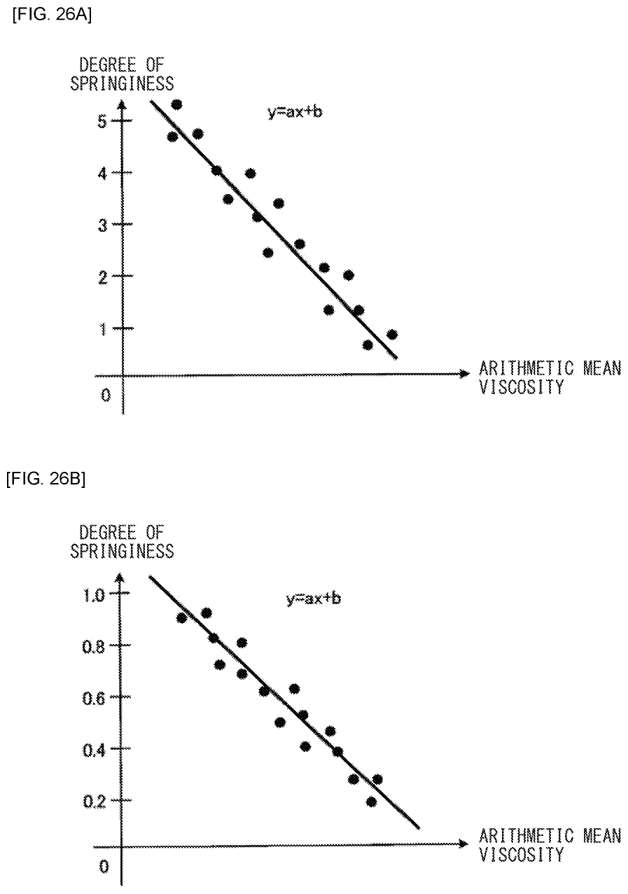

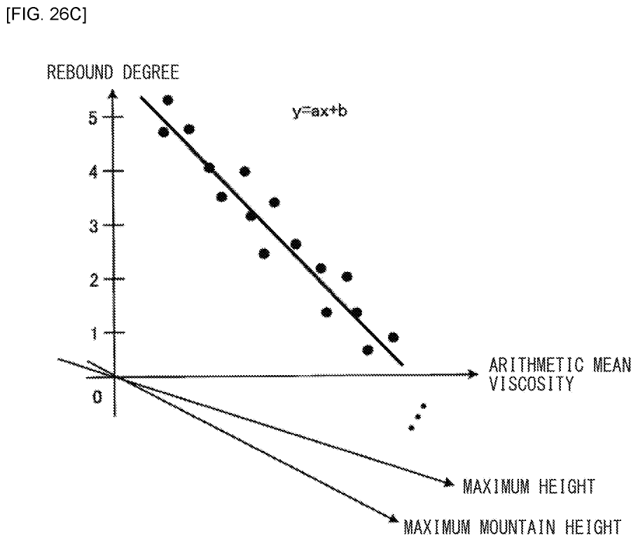

In a case where the calibration curve scheme (a third estimation scheme) is selected, the estimation section 165 substitutes shear elastic modulus (G) or shear viscous modulus (u) into the calibration curve to calculate the contact sense information. FIGS. 25A to 25C and 26A to 26C each illustrate an example of the calibration curve. A creator of the calibration curve creates a calibration curve in advance for each type and each material of an object. For example, the calibration curve is able to be created as follows. First, the creator of the calibration curve prepares samples having a shear elastic modulus (Gₘᵢₙ≤G≤Gₘₐₓ) and a shear viscous modulus (uₘᵢₙ≤u≤uₘₐₓ) for various materials. Then, the creator asks a plurality of examinees to make sensory evaluation of a rebound degree and a degree of springiness of the samples. Then, the creator creates a calibration curve on the basis of information on the sensory evaluation by the plurality of examinees, for example, as illustrated in FIG. FIGS. 25A and 26A.

It is to be noted that creator may use the shear elastic modulus or the shear viscous modulus, instead of the sensory evaluation of the examinees, to create the calibration curve. In this case, the calibration curve becomes a calibration curve as illustrated in FIGS. 25B and 26B. The shear elastic modulus and the shear viscous modulus are each also one type of the contact sense information.

In addition, the creator may create a calibration curve for calculation of the contact sense information on the basis of a plurality of viscoelastic moduli (shear elastic moduli or shear viscous moduli). FIGS. 25C and 26C are each an example of a calibration curve for calculation of the contact sense information on the basis of the plurality of viscoelastic moduli.

In the machine learning scheme, the estimation section 165 cuts out a measurement range from the image captured by the camera 152 and inputs the cut-out data to the learning model to thereby acquire tactile information. The learning model may be a model based on the CNN.

The management section 166 stores the contact sense information obtained by the estimation section 165 in the storage unit 14.

[Case where Person him or Herself Wearing Prosthetic Arm Obtains Tactile Sensation of Another Person by Shaking Hands and Gripping Tool]

The deciding section 167 decides a grip position and grip force of the object T. The deciding section 167 includes the grip position deciding part 167a and the grip force deciding part 167b.

The grip position deciding part 167a locates a position of an object to be touched by a prosthetic arm on the basis of measured data of the camera 152 and the distance measure 153, and decides a position to be gripped by the grip unit 17. Various methods may be used to decide the grip position. For example, the grip position deciding part 167a is able to locate the grip position from an image and distance information by using a report at Information Processing Society of Japan (e.g., “three-dimensional position orientation estimation using RGB-D camera for bin picking, and scoring method in consideration of graspability”, Information Processing Society of Japan, research report) and a method described in a paper by researchers of Chubu University (e.g., a “Grasping detection using deep convolutional neural network with graspability”).

The grip force deciding part 167b decides grip force on the basis of the contact sense (e.g., frictional coefficient) estimated by the estimation section 165. Various methods may be used to decide a grip position. For example, the grip force deciding part 167b is able to decide the grip force using the method described in PTL 2, “Gripping force control method of robot hand”. In addition, the grip force deciding part 167b may decide the grip force depending on the material quality of the object determined by the material determination part 163b.

In addition, in a case where a tactile device is disposed on a surface for gripping (palm of the hand), the grip force is adjusted in consideration of a surface frictional coefficient and viscoelasticity of the tactile device. The same applies to limit processing in a case where overload occurs on the tactile device, the prosthetic arm, and the human body.

The presentation part 182a is disposed on a gripping surface (the skin such as palm of the hand) or inside the socket section 182 not to adversely affect the connection with the socket. For example, the presentation part 182a is fixed by close contact between the soft tissue and the socket.

The tactile sensation control section 169 includes a contact region determination part 169a and a viscosity/elasticity deciding part 169b. The contact region determination part 169a makes a determination as to the contact between the prosthetic arm and another person touching the prosthetic arm as well as prediction of a contact range, from an image. Then, in a case where another person touches the prosthetic arm, tactile senses of the following two conditions are presented simultaneously.

Another person to shake hands are presented with a tactile sensation acquired in advance from a normal hand of a person him or herself who wears the prosthetic arm, from a presentation part 183a disposed on the finger pad part of the prosthetic arm. The tactile sensation to be presented is decided by the viscosity/elasticity deciding part 169b on the basis of the contact sense information stored in the storage unit 14. The tactile sensation control section 169 controls the presentation part 183a on the basis of the determination of the contact region determination part 169a and the decision of the viscosity/elasticity deciding part 169b. The same applies to a case of touching the skin of the arm other than the finger pad part of the hand.

The user who wears the prosthetic arm is presented with a tactile sensation of the hand of another person from the presentation part 182a disposed inside the socket section 182. The tactile sensation to be presented is decided by the viscosity/elasticity deciding part 169b on the basis of the contact sense information generated by the estimation section 165. The tactile sensation control section 169 controls the presentation part 182a on the basis of the determination of the contact region determination part 169a and the decision of the viscosity/elasticity deciding part 169b.

### <5-2. Operation of Estimation Apparatus>

Next, description is given of an operation of the estimation apparatus 10.

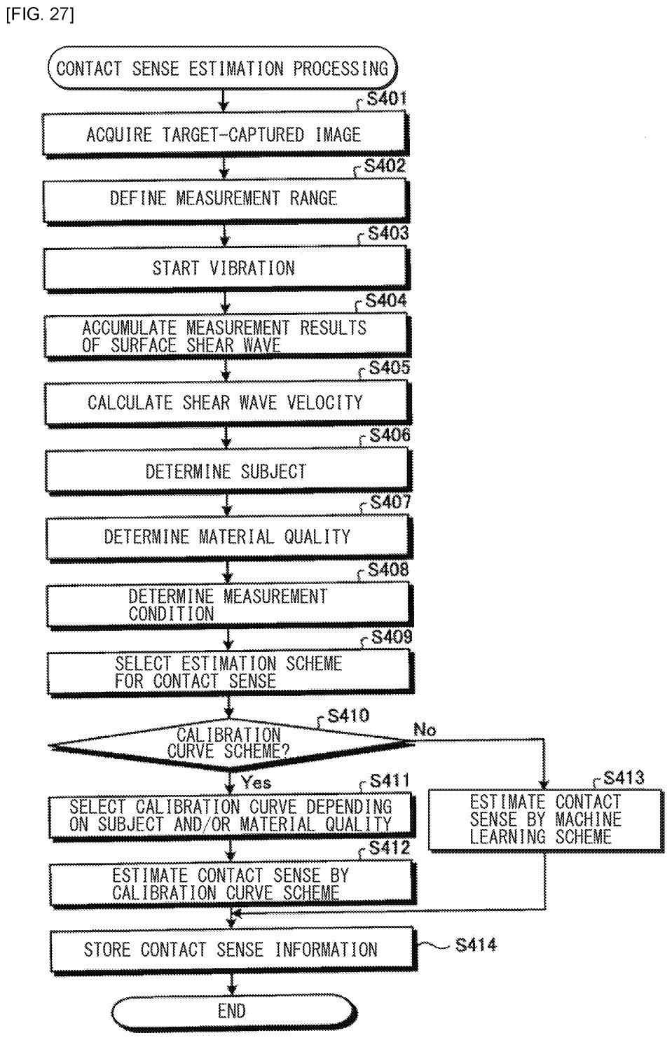

FIG. 27 is a flowchart illustrating contact sense estimation processing according to Embodiment 5. The contact sense estimation processing is processing for contactless estimation of the contact sense of the object T to be an estimation target of the contact sense. The object T need not necessarily be the normal hand of a user who wears the prosthetic arm. The estimation apparatus 10 starts the contact sense estimation processing upon receiving a command from the user via the communication unit 11 or the input unit 12, for example.

First, the acquisition section 161 of the estimation apparatus 10 acquires an image captured by the camera 152 (step S401). Then, the acquisition section 161 defines a measurement range of the object T (step S402). Then, the vibrating unit 19 of the estimation apparatus 10 starts vibration to the measurement range (step S403). Then, the measurement unit 15 of the estimation apparatus 10 accumulates measurement results of a surface shear wave (step S404). Then, the calculation section 162 of the estimation apparatus 10 calculates a shear wave velocity on the basis of the measurement results (step S405). The calculation section 162 may calculate a viscoelastic modulus of the object T on the basis of the shear wave velocity.

Subsequently, the determination section 163 of the estimation apparatus 10 determines the type of the object T, i.e., what the subject is, on the basis of the image captured by the camera 152 (step S406). In addition, the determination section 163 determines the material quality of the object T on the basis of the image captured by the camera 152 (step S407). Further, the determination section 163 determines the measurement condition of the object T by the measurement unit 15 (step S408).

Subsequently, the selection section 164 of the estimation apparatus 10 selects, from among a plurality of estimation schemes, an estimation scheme to be used for the estimation of the contact sense of the object T by the estimation apparatus 10 on the basis of the determination results of the determination section 163 (step S409). For example, the selection section 164 selects, on the basis of determination results in step S408, whether the estimation apparatus 10 uses the calibration curve scheme (third estimation scheme) to estimate the contact sense of the object T, or the estimation apparatus 10 uses the machine learning scheme (a fourth calibration curve) to estimate the contact sense of the object T.

Subsequently, the estimation section 165 of the estimation apparatus 10 determines whether or not the calibration curve scheme is selected by the selection section 164 (step S410). In a case where the calibration curve scheme is selected (step S410: Yes), the selection section 164 selects a calibration curve corresponding to the type and/or material of the object T from among a plurality of calibration curves on the basis of determination results in step S406 and/or step S407 (step S411). The selection of the calibration curve may also be regarded as the selection of an estimation scheme. The estimation section 165 uses the selected calibration curve to estimate the contact sense of the object T (step S412).

Meanwhile, in a case where the machine learning scheme is selected (step S410: No), the estimation section 165 estimates the contact sense of the object T using the machine learning scheme (step S413). At this time, the learning model to be used for the estimation of the contact sense may be selected from among a plurality of learning models on the basis of the determination results in step S406 and/or step S407. The selection of the learning model may also be regarded as the selection of an estimation scheme.

The management section 166 of the estimation apparatus 10 stores, in the storage unit 14, the contact sense information generated in the processing of step S412 or step S413 (step S414). Upon completion of the storage, the estimation apparatus 10 finishes the contact sense estimation processing. The tactile sensation control section 169 controls the presentation part 182a or the presentation part 183a on the basis of the contact sense information.

According to the present embodiment, the estimation apparatus 10 estimates the contact sense on the basis of a change in the measured data in the temporal direction, thus making it possible to obtain highly accurate contact sense information.

In addition, the estimation apparatus 10 is able to feed back an appropriate tactile sensation that causes no discomfort to a person who touches the brace, in advance. It is to be noted that, in the above-described embodiment, the description is given by exemplifying the prosthetic arm, but the brace is not limited to the prosthetic arm. The term “prosthetic arm” described above may be replaced with another term of the brace such as a “prosthetic leg” as appropriate.

### 6. Modification Examples

A control device that controls the estimation apparatus 10 of any of the present embodiments may be implemented by a dedicated computer system, or may be implemented by a general-purpose computer system.

For example, an estimation program for executing the above-described operations (e.g., contact sense estimation processing, commodity information transmission processing, or grip control processing, etc.) is stored in a computer-readable recording medium such as an optical disk, a semiconductor memory, a magnetic tape and a flexible disk, and is distributed. Then, for example, the program is installed in a computer, and the above-described processing is executed, to thereby configure the control device. At this time, the control device may be a device outside the estimation apparatus 10 (e.g., a personal computer) or a device inside the estimation apparatus 10 (e.g., the control unit 16).

In addition, the above communication program may be stored in a disk device included in a server apparatus on a network such as the Internet to enable, for example, downloading to a computer. In addition, the above-described functions may be implemented by cooperation between an OS (Operating System) and application software. In this case, a portion other than the OS may be stored in a medium for distribution, or a portion other than the OS may be stored in a server apparatus to enable, for example, downloading to a computer.

In addition, every or some processing described in the foregoing embodiments as being performed automatically may be performed manually, or every or some processing described as being performed manually may be performed automatically in a known method. Aside from those described above, the information including processing procedures, specific names, and various types of data and parameters illustrated herein and drawings may be arbitrarily changed unless otherwise specified. For example, the various types of information illustrated in the drawings are not limited to the illustrated information.

In addition, the illustrated respective components of the apparatuses are functional and conceptual, and do not necessarily need to be physically configured as illustrated. That is, the specific form of discreteness and integration of the apparatuses is not limited to those illustrated, and all or a portion thereof may be functionally or physically configured discretely and integrally in an arbitrary unit, depending on various loads, statuses of use, or the like.

Further, the above-described embodiments may be appropriately combined in a region with no contradiction in a processing content. In addition, the order of the steps illustrated in the flowcharts of the present embodiments may be changed appropriately.

### 7. Closing

As described above, according to an embodiment of the present disclosure, the estimation apparatus 10 estimates the contact sense of the object T using an optimum estimation scheme corresponding to an aspect of an object or a measurement condition of the object. This enables the estimation apparatus 10 to accurately estimate the contact sense of the object in a contactless manner, regardless of the aspect or the measurement condition of the object.

The description has been given above of the respective embodiments of the present disclosure; however, the technical scope of the present disclosure is not limited to the foregoing respective embodiments as they are, and various alterations may be made without departing from the gist of the present disclosure. In addition, components throughout different embodiments and modification examples may be combined appropriately.

In addition, the effects in the respective embodiments described herein are merely illustrative and non-limiting, and may have other effects.

It is to be noted that the present technology may also have the following configurations.

(1)

An estimation apparatus including:

an acquisition section that acquires a measurement result of a measurement unit that measures an object to be an estimation target of a contact sense in a contactless manner;

a determination section that makes a determination as to an aspect of the object or a measurement condition of the object on a basis of the measurement result of the measurement unit;

a selection section that selects, on a basis of a result of the determination, an estimation scheme to be used for estimation of the contact sense of the object from among a plurality of estimation schemes; and

an estimation section that estimates the contact sense of the object using the selected estimation scheme.

(2)

The estimation apparatus according to (1), in which

the determination section determines, on a basis of the measurement result, whether or not the measurement condition of the object satisfies a predetermined standard, and

the selection section selects, on a basis of a result of the determination of the measurement condition of the object, an estimation scheme to be used for the estimation of the contact sense of the object from among the plurality of estimation schemes.

(3)

The estimation apparatus according to (1) or (2), in which

the measurement unit includes at least a first measure that measures unevenness on a surface of the object,

the selection section selects a first estimation scheme that uses a measurement result of the first measure in a case where the measurement condition of the object satisfies the predetermined standard, and

the selection section selects a second estimation scheme that does not use the measurement result of the first measure in a case where the measurement condition of the object does not satisfy the predetermined standard.

(4)

The estimation apparatus according to (3), in which the first estimation scheme includes an estimation scheme that converts information on surface roughness of the object acquired by the measurement result of the first measure into contact sense information on a basis of sensory evaluation information generated by sensory evaluation of a relationship between the surface roughness and the contact sense.

(5)

The estimation apparatus according to (3) or (4), in which

the measurement unit includes at least a camera that captures an image of the object, and

the second estimation scheme includes an estimation scheme that uses information on the image captured by the camera.

(6)

The estimation apparatus according to (5), in which the second estimation scheme includes a machine learning scheme that estimates the contact sense of the object using a learning model learned to output the information concerning the contact sense of the object in a case where the information on the image captured by the camera is inputted.

(7)

The estimation apparatus according to (1) or (2), in which

the measurement unit includes at least a second measure configured to grasp a change in a shear wave on a surface of the object during vibration,

the selection section selects a third estimation scheme that uses a measurement result of the second measure in a case where the measurement condition of the object satisfies the predetermined standard, and

the selection section selects a fourth estimation scheme that does not use the measurement result of the second measure in a case where the measurement condition of the object does not satisfy the predetermined standard.

(8)

The estimation apparatus according to any one of (1) to (7), in which

the measurement unit includes at least a distance sensor that measures a distance to the object,

the measurement condition of the object includes at least the distance to the object,

the determination section determines whether or not the distance to the object satisfies the predetermined standard, and

the selection section selects, on a basis of information on whether or not the distance to the object satisfies the predetermined standard, an estimation scheme to be used for the estimation of the contact sense of the object from among the plurality of estimation schemes.

(9)

The estimation apparatus according to (8), in which

the measurement unit includes at least the first measure that measures the unevenness on the surface of the object,

the selection section selects a first determination scheme that uses the measurement result of the first measure in a case where the distance to the object satisfies the predetermined standard, and

the selection section selects a second determination scheme that does not use the measurement result of the first measure in a case where the distance to the object does not satisfy the predetermined standard.

(10)

The estimation apparatus according to any one of (1) to (9), in which

the measurement unit includes at least the camera that captures an image of the object,

the measurement condition of the object includes at least an imaging condition of the object by the camera,

the determination section determines whether or not the imaging condition satisfies the predetermined standard, and

the selection section selects, on a basis of information on whether or not the imaging condition satisfies the predetermined standard, an estimation scheme to be used for the estimation of the contact sense of the object from among the plurality of estimation schemes.

(11)

The estimation apparatus according to any one of (1) to (10), in which

the determination section determines the aspect of the object on a basis of the measurement result, and

the selection section selects, on a basis of a result of the determination of the aspect of the object, an estimation scheme to be used for the estimation of the contact sense of the object from among the plurality of estimation schemes.

(12)

The estimation apparatus according to (11), in which

the determination section determines at least a type or a material of the object as the aspect of the object, and

the selection section selects, on a basis of the determined type or material of the object, an estimation scheme to be used for the estimation of the contact sense of the object from among the plurality of estimation schemes.

(13)

The estimation apparatus according to (12), in which

the measurement unit includes at least the first measure that measures the unevenness on the surface of the object, and

the estimation scheme to be used for the estimation of the contact sense of the object includes an estimation scheme that converts the information on the surface roughness of the object acquired by the measurement result of the first measure into the contact sense information on a basis of the sensory evaluation information generated by the sensory evaluation of the relationship between the surface roughness and the contact sense,

the sensory evaluation information differs for each type or for each material of the object, and

the selection section selects an estimation scheme that estimates the contact sense of the object using the sensory evaluation information corresponding to the determined type or material of the object from among a plurality of estimation schemes in each of which the sensory evaluation information is different.

(14)

The estimation apparatus according to any one of (1) to (13), in which

the object includes a commodity of an electronic commerce transaction, and

the estimation apparatus includes a management section that records or transmits, as information on the commodity, information on the contact sense estimated by the estimation section.

(15)

The estimation apparatus according to any one of (1) to (13), including

a grip unit that grips the object; and

a deciding section that decides grip force or a grip position when the grip unit grips the object, on a basis of information on the contact sense of the object estimated by the estimation section.

(16)

The estimation apparatus according to any one of (1) to (13), in which

the object includes a brace,

the brace includes a first presentation part that presents a tactile sensation of the brace to a person who comes into contact with the brace, and

the estimation apparatus includes a tactile sensation control section that controls the first presentation part on a basis of a result of the estimation of the estimation section.

(17)

The estimation apparatus according to any one of (1) to (13), in which

the object includes a predetermined object that comes into contact with a brace,

the brace includes a second presentation part that presents a tactile sensation of the predetermined object to a user who wears the brace, and

the estimation apparatus includes a tactile sensation control section that controls the second presentation part on a basis of a result of the estimation of the estimation section.

(18)

An estimation method including:

acquiring a measurement result of a measurement unit that measures an object to be an estimation target of a contact sense in a contactless manner;

making a determination as to an aspect of the object or a measurement condition of the object on a basis of the measurement result of the measurement unit;

selecting, on a basis of a result of the determination, an estimation scheme to be used for estimation of the contact sense of the object from among a plurality of estimation schemes; and

estimating the contact sense of the object using the selected estimation scheme.

(19)

An estimation program that causes a computer to function as:

an acquisition section that acquires a measurement result of a measurement unit that measures an object to be an estimation target of a contact sense in a contactless manner;

a determination section that makes a determination as to an aspect of the object or a measurement condition of the object on a basis of the measurement result of the measurement unit;

a selection section that selects, on a basis of a result of the determination, an estimation scheme to be used for estimation of the contact sense of the object from among a plurality of estimation schemes; and

an estimation section that estimates the contact sense of the object using the selected estimation scheme.

### REFERENCE NUMERALS LIST

1 estimation system
10 estimation apparatus
11 communication unit
12 input unit
13 output unit
14 storage unit
15 measurement unit
16 control unit
17 grip unit
18 prosthetic arm unit
19 vibrating unit
20 server
30 terminal apparatus
151 surface unevenness measure
152 camera
153 distance measure
154 vibration measure
161 acquisition section
162 calculation section
162a surface roughness calculation part
162b viscoelasticity calculation part
163 determination section
163a subject determination part
163b material determination part
163c measurement condition determination part
164 selection section
165 estimation section
166 management section
167 deciding section
167a grip position deciding part
167b grip force deciding part
168 grip control section
169 tactile sensation control section
169a contact region determination part
169b viscosity/elasticity deciding part
181 grip section
182 socket section
182a, 183a presentation part
183 exterior section

1. An estimation apparatus comprising:
an acquisition section that acquires a measurement result of a measurement unit that measures an object to be an estimation target of a contact sense in a contactless manner;
a determination section that makes a determination as to an aspect of the object or a measurement condition of the object on a basis of the measurement result of the measurement unit;
a selection section that selects, on a basis of a result of the determination, an estimation scheme to be used for estimation of the contact sense of the object from among a plurality of estimation schemes; and
an estimation section that estimates the contact sense of the object using the selected estimation scheme.

2. The estimation apparatus according to claim 1, wherein
the determination section determines, on a basis of the measurement result, whether or not the measurement condition of the object satisfies a predetermined standard, and
the selection section selects, on a basis of a result of the determination of the measurement condition of the object, an estimation scheme to be used for the estimation of the contact sense of the object from among the plurality of estimation schemes.

3. The estimation apparatus according to claim 2, wherein
the measurement unit includes at least a first measure that measures unevenness on a surface of the object,
the selection section selects a first estimation scheme that uses a measurement result of the first measure in a case where the measurement condition of the object satisfies the predetermined standard, and
the selection section selects a second estimation scheme that does not use the measurement result of the first measure in a case where the measurement condition of the object does not satisfy the predetermined standard.

4. The estimation apparatus according to claim 3, wherein the first estimation scheme comprises an estimation scheme that converts information on surface roughness of the object acquired by the measurement result of the first measure into contact sense information on a basis of sensory evaluation information generated by sensory evaluation of a relationship between the surface roughness and the contact sense.

5. The estimation apparatus according to claim 4, wherein
the measurement unit includes at least a camera that captures an image of the object, and
the second estimation scheme comprises an estimation scheme that uses information on the image captured by the camera.

6. The estimation apparatus according to claim 5, wherein the second estimation scheme comprises a machine learning scheme that estimates the contact sense of the object using a learning model learned to output the information concerning the contact sense of the object in a case where the information on the image captured by the camera is inputted.

7. The estimation apparatus according to claim 2, wherein
the measurement unit includes at least a second measure configured to grasp a change in a shear wave on a surface of the object during vibration,
the selection section selects a third estimation scheme that uses a measurement result of the second measure in a case where the measurement condition of the object satisfies the predetermined standard, and
the selection section selects a fourth estimation scheme that does not use the measurement result of the second measure in a case where the measurement condition of the object does not satisfy the predetermined standard.

8. The estimation apparatus according to claim 2, wherein
the measurement unit includes at least a distance sensor that measures a distance to the object,
the measurement condition of the object includes at least the distance to the object,
the determination section determines whether or not the distance to the object satisfies the predetermined standard, and
the selection section selects, on a basis of information on whether or not the distance to the object satisfies the predetermined standard, an estimation scheme to be used for the estimation of the contact sense of the object from among the plurality of estimation schemes.

9. The estimation apparatus according to claim 8, wherein
the measurement unit includes at least a first measure that measures unevenness on a surface of the object,
the selection section selects a first determination scheme that uses a measurement result of the first measure in a case where the distance to the object satisfies the predetermined standard, and
the selection section selects a second determination scheme that does not use the measurement result of the first measure in a case where the distance to the object does not satisfy the predetermined standard.

10. The estimation apparatus according to claim 2, wherein
the measurement unit includes at least a camera that captures an image of the object,
the measurement condition of the object includes at least an imaging condition of the object by the camera,
the determination section determines whether or not the imaging condition satisfies the predetermined standard, and
the selection section selects, on a basis of information on whether or not the imaging condition satisfies the predetermined standard, an estimation scheme to be used for the estimation of the contact sense of the object from among the plurality of estimation schemes.

11. The estimation apparatus according to claim 1, wherein
the determination section determines the aspect of the object on a basis of the measurement result, and
the selection section selects, on a basis of a result of the determination of the aspect of the object, an estimation scheme to be used for the estimation of the contact sense of the object from among the plurality of estimation schemes.

12. The estimation apparatus according to claim 11, wherein
the determination section determines at least a type or a material of the object as the aspect of the object, and
the selection section selects, on a basis of the determined type or material of the object, an estimation scheme to be used for the estimation of the contact sense of the object from among the plurality of estimation schemes.

13. The estimation apparatus according to claim 12, wherein
the measurement unit includes at least a first measure that measures unevenness on a surface of the object, and
the estimation scheme to be used for the estimation of the contact sense of the object comprises an estimation scheme that converts information on surface roughness of the object acquired by a measurement result of the first measure into contact sense information on a basis of sensory evaluation information generated by sensory evaluation of a relationship between the surface roughness and the contact sense,
the sensory evaluation information differs for each type or for each material of the object, and
the selection section selects an estimation scheme that estimates the contact sense of the object using the sensory evaluation information corresponding to the determined type or material of the object from among a plurality of estimation schemes in each of which the sensory evaluation information is different.

14. The estimation apparatus according to claim 1, wherein
the object comprises a commodity of an electronic commerce transaction, and
the estimation apparatus comprises a management section that records or transmits, as information on the commodity, information on the contact sense estimated by the estimation section.

15. The estimation apparatus according to claim 1, comprising
a grip unit that grips the object; and
a deciding section that decides grip force or a grip position when the grip unit grips the object, on a basis of information on the contact sense of the object estimated by the estimation section.

16. The estimation apparatus according to claim 1, wherein
the object comprises a brace,
the brace includes a first presentation part that presents a tactile sensation of the brace to a person who comes into contact with the brace, and
the estimation apparatus comprises a tactile sensation control section that controls the first presentation part on a basis of a result of the estimation of the estimation section.

17. The estimation apparatus according to claim 1, wherein
the object comprises a predetermined object that comes into contact with a brace,
the brace includes a second presentation part that presents a tactile sensation of the predetermined object to a user who wears the brace, and
the estimation apparatus comprises a tactile sensation control section that controls the second presentation part on a basis of a result of the estimation of the estimation section.

18. An estimation method comprising:
acquiring a measurement result of a measurement unit that measures an object to be an estimation target of a contact sense in a contactless manner;
making a determination as to an aspect of the object or a measurement condition of the object on a basis of the measurement result of the measurement unit;
selecting, on a basis of a result of the determination, an estimation scheme to be used for estimation of the contact sense of the object from among a plurality of estimation schemes; and
estimating the contact sense of the object using the selected estimation scheme.

19. An estimation program that causes a computer to function as:
an acquisition section that acquires a measurement result of a measurement unit that measures an object to be an estimation target of a contact sense in a contactless manner;
a determination section that makes a determination as to an aspect of the object or a measurement condition of the object on a basis of the measurement result of the measurement unit;
a selection section that selects, on a basis of a result of the determination, an estimation scheme to be used for estimation of the contact sense of the object from among a plurality of estimation schemes; and
an estimation section that estimates the contact sense of the object using the selected estimation scheme.
